(19) United States
(12) Patent Application Publication
(10) Pub. No.: US 2026/0244560 A1
(43) Pub. Date: Aug. 20, 2026

(54) SUB-APPLICATION GENERATION METHOD AND APPARATUS, COMPUTER DEVICE, AND READABLE STORAGE MEDIUM

(71) Applicant: TENCENT TECHNOLOGY (SHENZHEN) COMPANY LIMITED, Shenzhen (CN)

(72) Inventors: Jiamin HUANG, Shenzhen (CN); Fengmian GUO, Shenzhen (CN); Canhui HUANG, Shenzhen (CN); Ruiying ZHU, Shenzhen (CN)

(21) Appl. No.: 19/645,981

(22) Filed: Apr. 13, 2026

Related U.S. Application Data
(63) Continuation of application No. PCT/CN2025/070519, filed on Jan. 3, 2025.

(30) Foreign Application Priority Data
Jan. 25, 2024 (CN) 202410114801.4

(51) Int. Cl. G06F 11/3698

(52) U.S. Cl. CPC G06F 11/3698

(57) ABSTRACT

A method includes displaying a sub-application development interface of a first application development platform, displaying, on the sub-application development interface, a template identifier of a sub-application page template provided by a second application development platform, displaying, in response to an identifier selection operation on the template identifier, a simulator region of the first application development platform and a configuration region for configuring a sub-application of the second application development platform, displaying, in the configuration region, the sub-application page template and sub-application components provided by the second application development platform, adding, in response to a component selection operation of selecting from the sub-application components, at least one sub-application component selected by the component selection operation into the sub-application page template, and displaying, in the simulator region, a simulated interaction page formed by simulating running of the sub-application generated using the sub-application page template and the at least one sub-application component.

### CROSS-REFERENCE TO RELATED APPLICATIONS

This application is a continuation of International Application No. PCT/CN2025/070519, filed on January 3, 2025, which claims priority to Chinese Patent Application No. 2024101148014, filed on January 25, 2024, and entitled "SUB-APPLICATION GENERATION METHOD AND APPARATUS, COMPUTER DEVICE, AND READABLE STORAGE MEDIUM," the entire contents of both of which are incorporated herein by reference.

### FIELD OF THE TECHNOLOGY

This application relates to the field of computer technologies, and in particular, to a sub-application generation method and apparatus, a computer device, a storage medium, and a computer program product.

### BACKGROUND OF THE DISCLOSURE

With the development of computer technologies, a sub-application generation technology appears. A user can generate, by using the sub-application generation technology, a sub-application satisfying a requirement of the user. For example, for a merchant on the Internet of Things, if a dedicated sub-application is required to provide a service to a customer, the merchant can generate the dedicated sub-application of the merchant.

In the related art, a specific type of sub-application is usually implemented through a specific type of application development platform. The application development platform provides some pre-configured templates, and a user can adjust these templates to generate a sub-application required by the user.

However, since different application development platforms can only provide development services for some types of sub-applications, when a user needs to generate a sub-application, the sub-application needs to be generated on an application development platform that can develop this type of sub-application. Consequently, sub-application development efficiency is low.

### SUMMARY

In accordance with the disclosure, there is provided a sub-application generation method including displaying a sub-application development interface of a first application development platform, displaying, on the sub-application development interface, a template identifier of a sub-application page template provided by a second application development platform, displaying, in response to an identifier selection operation on the template identifier, a simulator region of the first application development platform and a configuration region configured for configuring a sub-application of the second application development platform, displaying, in the configuration region, the sub-application page template and a plurality of sub-application components provided by the second application development platform, adding, in response to a component selection operation of selecting from the plurality of sub-application components, at least one sub-application component selected by the component selection operation into the sub-application page template, and displaying, in the simulator region, a simulated interaction page formed by simulating running of the sub-application generated using the sub-application page template and the at least one sub-application component.

Also in accordance with the disclosure, there is provided a computer device including a memory storing a computer program, and a processor configured to execute the computer program to display a sub-application development interface of a first application development platform, display, on the sub-application development interface, a template identifier of a sub-application page template provided by a second application development platform, display, in response to an identifier selection operation on the template identifier, a simulator region of the first application development platform and a configuration region configured for configuring a sub-application of the second application development platform, display, in the configuration region, the sub-application page template and a plurality of sub-application components provided by the second application development platform, add, in response to a component selection operation of selecting from the plurality of sub-application components, at least one sub-application component selected by the component selection operation into the sub-application page template, and display, in the simulator region, a simulated interaction page formed by simulating running of the sub-application generated using the sub-application page template and the at least one sub-application component.

Also in accordance with the disclosure, there is provided a non-transitory computer-readable storage medium storing a computer program that, when executed by a processor, causes a computer device including the processor to display a sub-application development interface of a first application development platform, display, on the sub-application development interface, a template identifier of a sub-application page template provided by a second application development platform, display, in response to an identifier selection operation on the template identifier, a simulator region of the first application development platform and a configuration region configured for configuring a sub-application of the second application development platform, display, in the configuration region, the sub-application page template and a plurality of sub-application components provided by the second application development platform, add, in response to a component selection operation of selecting from the plurality of sub-application components, at least one sub-application component selected by the component selection operation into the sub-application page template, and display, in the simulator region, a simulated interaction page formed by simulating running of the sub-application generated using the sub-application page template and the at least one sub-application component.

### BRIEF DESCRIPTION OF THE DRAWINGS

To describe the technical solutions in the embodiments of this application or the traditional art more clearly, the following briefly describes the accompanying drawings for describing the embodiments. Apparently, the accompanying drawings in the following descriptions show merely the embodiments of this application. A person of ordinary skill in the art may still derive other drawings from the disclosed accompanying drawings without creative efforts.

FIG. 1 is a diagram showing an application environment of a sub-application generation method in an embodiment.

FIG. 2 is a flowchart of a sub-application generation method in an embodiment.

FIG. 3 is a schematic interface diagram showing a template identifier being displayed on a sub-application development interface in an embodiment.

FIG. 4 is a schematic interface diagram showing a simulator region and a configuration region being displayed in the same interface in another embodiment.

FIG. 5 is a schematic interface diagram showing a simulator region and a configuration region being displayed on different interfaces, respectively, in another embodiment.

FIG. 6 is a schematic interface diagram showing a toolbar region, a simulator region, and a configuration region in an embodiment.

FIG. 7 is a schematic interface diagram showing a second application debugging interface overlaying a native debugging region in an embodiment.

FIG. 8 is a schematic interface diagram showing a template identifier being displayed on a project list page of a developer tool in an embodiment.

FIG. 9 is a schematic diagram showing an interface of a project creation logic customized by a third-party service provider in an embodiment.

FIG. 10 is a schematic diagram showing scanning, through a mobile phone, a two-dimensional barcode corresponding to a mini program, so as to display a mini program page on the mobile phone in an embodiment.

FIG. 11 is a sequence diagram showing creating a mini program project in an embodiment.

FIG. 12 is a schematic interface diagram showing a first application debugging interface being generated in an embedded rendering manner in an embodiment.

FIG. 13 is a sequence diagram showing generating a mini program by a developer tool after a mini program project is created in an embodiment.

FIG. 14 is a structural block diagram of a sub-application generation apparatus in an embodiment.

FIG. 15 is a diagram showing an internal structure of a computer device in an embodiment.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts shall fall within the protection scope of this application.

A sub-application generation method provided in the embodiments of this application may be applied to generating various types of sub-applications, and may be applied to various scenes such as a cloud technology, artificial intelligence, intelligent traffic, and assisted driving. For example, a navigation type sub-application which is a generated sub-application configured for providing a navigation function for a user. The sub-application generation method provided in this application at least relates to the following technologies such as an intelligent traffic system, an intelligent vehicle infrastructure cooperative system, and a computer vision technology.

The intelligent traffic system (ITS) may alternatively be referred to as an intelligent transportation system. An advanced science and technology (such as an information technology, a computer technology, a data communication technology, a sensor technology, an electronic control technology, an automatic control theory, operational research, and artificial intelligence) is effectively and comprehensively applied to transportation, service control, and vehicle manufacturing, and connection between vehicles, roads, and users is strengthened, thereby forming a comprehensive transportation system that ensures safety, enhances efficiency, improves environments, and saves energy. Alternatively,

the intelligent vehicle infrastructure cooperative system, referred to as an IVICS, is a development direction of the intelligent traffic system (ITS). The vehicle infrastructure cooperative system uses advanced wireless communication and new-generation Internet technologies and the like to comprehensively implement interaction of vehicle-to-vehicle dynamic real-time information and vehicle-to-road dynamic real-time information, and perform active vehicle safety control and road collaboration management based on acquisition and integration of full-time-and-space dynamic traffic information, to fully implement effective cooperation of people, vehicles and roads, ensure traffic safety, and improve traffic efficiency, thereby forming a safe, efficient, and environmentally friendly road traffic system.

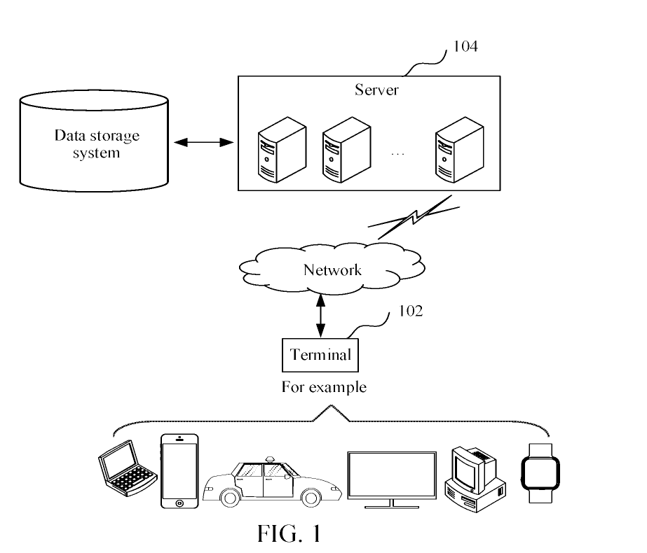

A sub-application generation method provided in embodiments of this application may be applied to an application environment shown in FIG. 1. A terminal 102 communicates with a server 104 through a network. A data storage system may store data that the server 104 needs to process. The data storage system may be integrated on the server 104, or placed on a cloud or other servers. The terminal 102 displays a sub-application development interface of a first application development platform, and displays, on the sub-application development interface, a template identifier of a sub-application page template provided by a second application development platform. The page template and the template identifier of the page template may be stored in the server 104. The terminal 102 displays, in response to an identifier selection operation on the template identifier, a simulator region of the first application development platform and a configuration region configured for configuring a sub-application of the second application development platform, and displays, in the configuration region, the sub-application page template and a plurality of sub-application components (also referred to as “candidate sub-application components”) provided by the second application development platform. The plurality of sub-application components may be stored in the server 104. The terminal 102 adds, in response to a component selection operation of selecting from the plurality of sub-application components, a sub-application component (also referred to as a “selected sub-application component”) selected by the component selection operation into the sub-application page template. The terminal 102 displays, in the simulator region, a simulated interaction page formed by simulating running of the sub-application, the sub-application being generated using the sub-application page template and the sub-application component that has been added into the sub-application page template.

The terminal 102 may be, but not limited to, various desktop computers, notebook computers, smart phones, tablet computers, Internet of Things devices, and portable wearable devices. The Internet of Things device may be a smart speaker, a smart television, a smart air condition, a smart in-vehicle device, or the like. The portable wearable device may be a smart watch, a smart band, a head-mounted device, and the like. The server 104 may be implemented using an independent server or a server cluster that includes a plurality of servers.

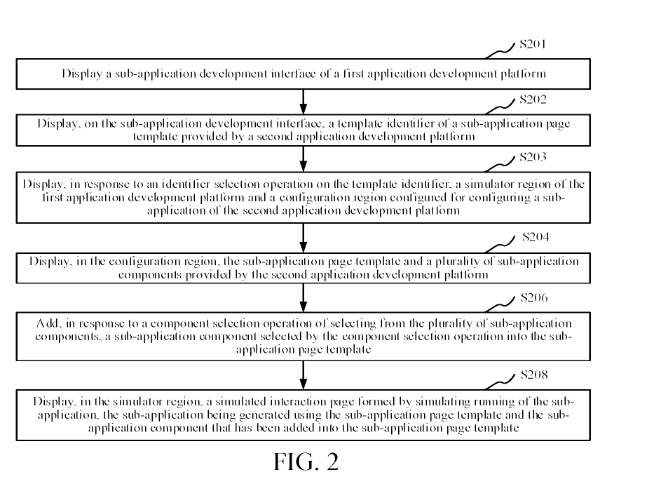

In one embodiment, as shown in FIG. 2, a sub-application generation method is provided. An example in which the method is applied to the terminal in FIG. 1 is used for description, including the following operations:

Operation S201: Display a sub-application development interface of a first application development platform.

Operation S202: Display, on the sub-application development interface, a template identifier of a sub-application page template provided by a second application development platform.

The application development platform refers to a platform providing a sub-application development service. The first application development platform refers to a tool configured for assisting a developer in developing and debugging a sub-application.

The second application development platform is also a platform providing a sub-application development service. The second application development platform is different from the first application development platform.

The sub-application page template is a page allowed to be laid and edited. The developer may edit a sub-application function on the sub-application page template. The template identifier is configured for identifying the sub-application page template. The template identifier may be specifically at least a part of content of the sub-application page template, may be a thumbnail of the sub-application page template, or may be a name, a serial number, or the like of the sub-application page template, but is not limited thereto.

The sub-application is an application that cannot be independently run and needs to be run using another application. That is, the sub-application is run in a parent application.

The sub-application may refer to an installation-free application program, that is, an application program that can be used without being downloaded and installed. Such application programs are usually run in a client as subprograms, and the client is referred to as a parent application.

The sub-application includes, but is not limited to, an instant messaging application, a short video application, a long video application, a game application, a music sharing application, a shopping and selling application, a user generated content (UGC) application, various intelligent recognition applications, and the like.

The sub-application may alternatively be a cloud application. The cloud application is an application run in a cloud. The cloud application is an application in which the terminal interacts with the cloud. A running manner of the cloud application is encoding, through a strong computing capability of a cloud simulator, a running process into audio and video streams which are transmitted to the terminal through a network, to implement interaction with a user.

The cloud is a cloud server, and is also referred to as a cloud server. The cloud server is based on a large-scale distributed computing system, and integrates computer resources through a virtualization technology, to provide services of Internet infrastructures. A network providing resources is referred to as "cloud." For a user, the resources in the "cloud" seem to be infinitely expandable, and may be obtained readily, used on demand, expanded readily, and paid for use. Cloud computing is a computing mode, in which computing tasks are distributed on a resource pool formed by a large number of computers, so that various application systems can obtain computing power, storage space, and information services according to requirements.

In this embodiment, the first application development platform may alternatively be a sub-application or a parent application. The second application development platform may alternatively be a sub-application or a parent application.

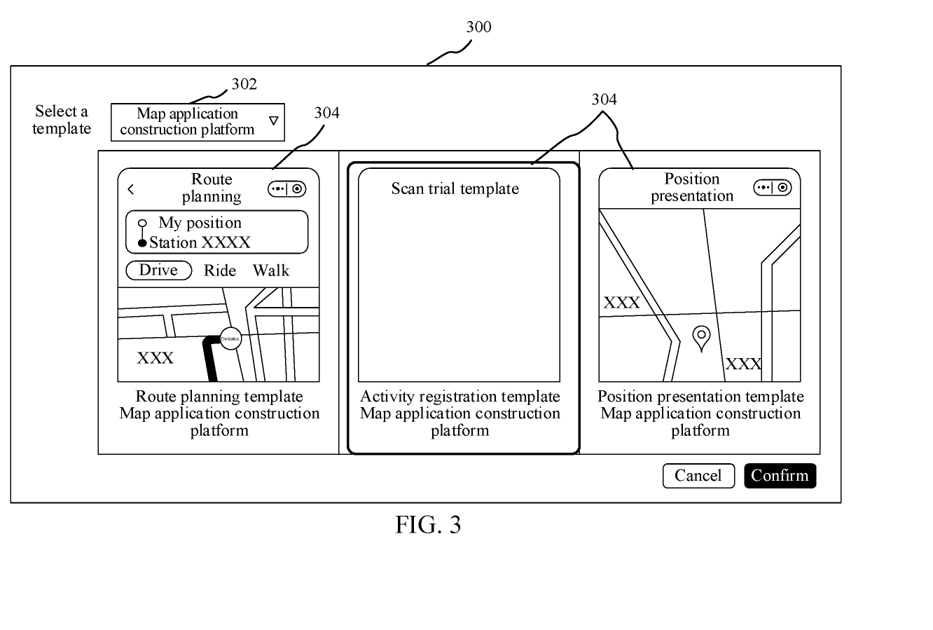

Specifically, a user may log in, through an application development account, to the first application development platform run in the terminal. The terminal displays the sub-application development interface of the first application development platform, and displays the at least one template identifier on the sub-application development interface. Each template identifier is configured for identifying one sub-application page template, and the sub-application page template is provided by the second application development platform. As shown in FIG. 3, a plurality of template identifiers 304 provided by a second application development platform 302 is displayed on a sub-application development interface 300.

In this embodiment, a quantity of sub-application page templates may be set based on a requirement. The sub-application page template may be a blank page, or may be a page in which some components are preconfigured.

Operation S203: Display, in response to an identifier selection operation on the template identifier, a simulator region of the first application development platform and a configuration region configured for configuring a sub-application of the second application development platform.

Operation S204: Display, in the configuration region, the sub-application page template and a plurality of sub-application components provided by the second application development platform.

The identifier selection operation is a preset operation acting on the template identifier. When the identifier selection operation is detected, selection of a corresponding template identifier may be triggered. The identifier selection operation may be specifically a touch operation, a cursor operation, a key operation, or a voice operation. The touch operation may be a touch and tap/click operation, a touch and press operation, or a touch and slide operation. The touch operation may be a single-point touch operation or a multi-point touch operation. The cursor operation may be an operation of controlling a cursor for tapping/clicking or an operation of controlling a cursor for pressing. The key operation may be a virtual key operation, a physical key operation, or the like.

The simulator region is a display region that is provided by the first application development platform and is configured for debugging a generated sub-application. The simulator region may be a pop-up window, a floating layer, an independent interface, or a part of a region in an independent interface.

The configuration region is a display region that is provided by the second application development platform and is configured for displaying the sub-application page template and the plurality of sub-application components. The configuration region may be a pop-up window, a floating layer, an independent interface, or a part of a region in an independent interface.

Specifically, the terminal determines, in response to the identifier selection operation performed by the developer on the template identifier, a template identifier selected by the identifier selection operation, and feeds back the template identifier selected by the identifier selection operation to the second application development platform through the first application development platform. The second application development platform determines, based on the fed-back template identifier, the sub-application page template identified by the fed-back template identifier.

The terminal displays the simulator region of the first application development platform and displays the configuration region configured for configuring the sub-application of the second application development platform. The sub-application page template identified by the selected template identifier and the plurality of sub-application components provided by the second application development platform are displayed in the configuration region.

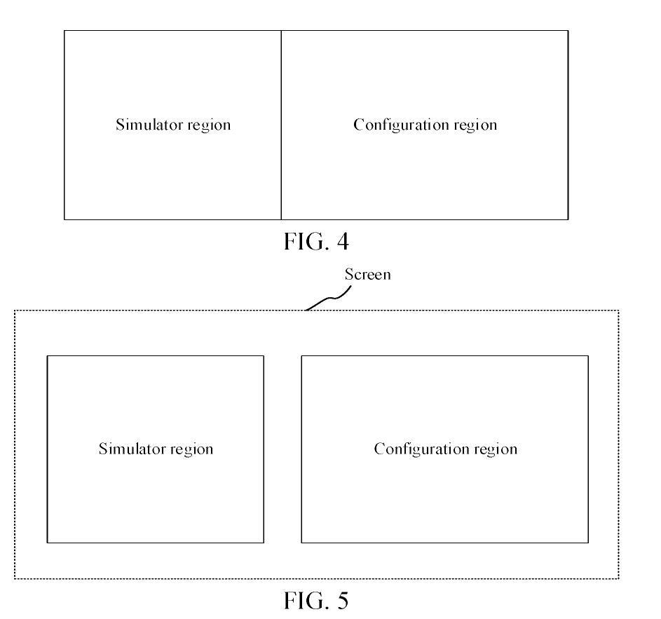

In this embodiment, the terminal may display the simulator region and the configuration region on the same screen. Displaying the simulator region and the configuration region on the same screen may be displaying the simulator region and the configuration region on the same interface, as shown in FIG. 4. Alternatively, the simulator region and the configuration region may be separately displayed on two interfaces of the same screen, as shown in FIG. 5.

In this embodiment, the terminal displays, in response to the identifier selection operation performed by the developer on the template identifier, the simulator region in the second application development platform, jumps from the first application development platform to the second application development platform, and displays the configuration region in the second application development platform. The sub-application page template identified by the selected template identifier and the plurality of sub-application components provided by the second application development platform are displayed in the configuration region.

In this embodiment, in response to the identifier selection operation on the template identifier, the sub-application page template represented by the template identifier selected by the identifier selection operation is displayed on the sub-application development interface. The simulator region and the configuration region are displayed in response to a selection completion event on the template identifier.

Operation S206: Add, in response to a component selection operation of selecting from the plurality of sub-application components, a sub-application component selected by the component selection operation into the sub-application page template.

Specifically, the terminal displays, in the configuration region, the plurality of sub-application components that can be used and the sub-application page template identified by the selected template identifier. The developer may select a component needing to be used from among the plurality of sub-application components, and add the selected component into the sub-application page template. The terminal receives the component selection operation performed by the developer on the plurality of sub-application components, determines the sub-application component selected by the component selection operation, and adds the sub-application component into the sub-application page template.

In this embodiment, the component selection operation includes, but is not limited to, a touch and hold operation, a tap/click operation, a slide operation, a moving operation, and a multi-point touch operation. Adding the component into the sub-application page template refers to copying the sub-application component selected by the developer from a component library interface into the sub-application page template.

For example, the developer may select a sub-application component that needs to be used from the plurality of sub-application components, and move the sub-application component that needs to be used into the sub-application page template. The terminal detects a moving operation performed by the developer on the sub-application component, determines a moving trajectory corresponding to the moving operation, and moves the sub-application component into the sub-application page template based on the moving trajectory.

Operation S208: Display, in the simulator region, a simulated interaction page formed by simulating running of the sub-application, the sub-application being generated using the sub-application page template and the sub-application component that has been added into the sub-application page template.

The terminal may display, in the simulator region in response to a simulation trigger event, the simulated interaction page formed by simulating the running of the sub-application. The simulation trigger event is an event configured for triggering debugging on the sub-application. The simulation trigger event may be specifically a touch operation, a cursor operation, a key operation, or a voice operation. The terminal may further display, in real time in the simulator region, the simulated interaction page formed by simulating the running of the sub-application. The terminal may further display, in the simulator region each time a change occurs in the configuration region, the simulated interaction page formed by simulating the running of the sub-application. The change may be at least one of adding a sub-application component, deleting a sub-application component, replacing a sub-application component, adjusting an attribute of a sub-application component, adjusting a layout of sub-application components, or the like.

The simulator region is a display region in which the running of the sub-application in the parent application is simulated through a simulator. The simulator is provided by the first application development platform, and can simulate the running of the sub-application in the parent application.

In this embodiment, the simulated interaction page of the sub-application is generated based on a native code of a page template and a component that has been added into the page template. The native code is generated by the second application development platform.

Specifically, the terminal displays the simulated interaction page of the sub-application in the simulator region in response to the simulation trigger event for the simulator region. The simulated interaction page is generated based on the sub-application page template and the sub-application component that has been added into the sub-application page template.

In this embodiment, the sub-application is generated by the second application development platform. The second application development platform generates the sub-application based on the sub-application page template on a configuration interface and the sub-application component that has been added into the sub-application page template. The terminal loads and runs the sub-application on the first application development platform through the simulator in response to the simulation trigger event for the simulator region, to display the simulated interaction page of the sub-application in the simulator region.

In this embodiment, the sub-application development interface of the first application development platform is displayed, to display, on the sub-application development interface of the first application development platform, the template identifier of the sub-application page template provided by the second application development platform. The first application development platform and the second application development platform can be combined, so that a user can select and use, on the first application development platform, the page template provided by the second application development platform to generate the sub-application. In response to the identifier selection operation on the template identifier, the simulator region of the first application development platform and the configuration region configured for configuring the sub-application of the second application development platform are displayed. The sub-application page template provided by the second application development platform and the plurality of sub-application components provided by the second application development platform are displayed in the configuration region configured for configuring the sub-application of the second application development platform. These page templates and components are provided by the second application development platform and are decoupled from the first application development platform itself, so that the user can freely invoke a page template and component of a third-party application development platform. In response to the component selection operation of selection among from the plurality of sub-application components, the sub-application component selected by the component selection operation is added into the sub-application page template. In response to the simulation trigger event for the simulator region, the simulated interaction page of the sub-application is displayed in the simulator region. The simulated interaction page is generated based on the sub-application page template and the sub-application component that has been added into the sub-application page template. These page templates and components are provided by the second application development platform and are decoupled from the first application development platform itself, thereby expanding a sub-application development function through the first application development platform. In addition, the sub-application can be generated through visualized component selection, and a user does not need to write codes, so that a user that does not understand codes can also generate a customized sub-application, thereby making sub-application development easier and enhancing sub-application development efficiency.

In one embodiment, the displaying, in response to an identifier selection operation on the template identifier, a simulator region of the first application development platform and a configuration region configured for configuring a sub-application of the second application development platform includes:

displaying a first application debugging interface in response to the identifier selection operation on the template identifier; and displaying, on the first application debugging interface, the simulator region provided by the first application development platform and the configuration region configured for configuring the sub-application of the second application development platform.

Specifically, the terminal determines, in response to the identifier selection operation performed by the developer on the template identifier, the template identifier selected by the identifier selection operation, and determines the sub-application page template represented by the selected template identifier. The template identifier and the sub-application page template are provided by the second application development platform.

The terminal displays the first application debugging interface provided by the first application development platform. The first application debugging interface includes the simulator region provided by the first application development platform and the configuration region configured for configuring the sub-application of the second application development platform. The terminal displays, in the configuration region, the sub-application page template provided by the second application development platform, and displays the plurality of sub-application components provided by the second application development platform.

The developer may perform component selection on the plurality of sub-application components displayed in the configuration region, to add the sub-application component selected by the component selection operation into the sub-application page template, and generate, through the second application development platform, the sub-application based on the sub-application page template and the sub-application component that has been added into the sub-application page template.

The simulated interaction page of the sub-application is displayed in the simulator region in response to the simulation trigger event performed by the developer on the simulator region.

In this embodiment, the first application debugging interface provided by the first application development platform is displayed in response to the identifier selection operation on the template identifier, so that the simulator region provided by the first application development platform and the configuration region configured for configuring the sub-application of the second application development platform can be simultaneously displayed on the first application debugging interface, and the sub-application configured by the developer in the configuration region can be run in the simulator region. The developer can configure the sub-application and debug the sub-application on the same interface, so that the sub-application development is easier, and it helps to enhance a user experience.

In one embodiment, the first application debugging interface further includes a toolbar region provided by the first application development platform. The displaying, in the simulator region, a simulated interaction page formed by simulating running of the sub-application includes:

displaying a simulator trigger control in the toolbar region; and displaying, in the simulator region in response to a trigger operation on the simulator trigger control, the simulated interaction page formed by simulating the running of the sub-application.

The simulator trigger control is an interaction element that is displayed in the toolbar region and can be operated by a user. The interaction element is a visual element. The visual element refers to an element that can be displayed and visible to human eyes and is configured for conveying information. The interaction element may be manifested in various forms. For example, it may be at least one of a control, an image, text, an identifier, a link, or an animation file, but is not limited thereto. The control may be a button, a blank box, a radio button, or an option group.

The simulator trigger control is a control configured for triggering displaying the simulated interaction page of the sub-application in the simulator region. The simulated interaction page refers to an interaction page of the sub-application displayed in the simulator region when the running of the sub-application is simulated.

The first application debugging interface further includes the toolbar region provided by the first application development platform. The simulator trigger control is displayed in the toolbar region.

Specifically, the terminal displays, in response to the identifier selection operation on the template identifier, the first application debugging interface including the toolbar region, the simulator region, and the configuration region. The toolbar region and the simulator region are provided by the first application development platform, and the configuration region is provided by the second application development platform.

The simulator trigger control is displayed in the toolbar region. The developer triggers the simulator trigger control, and may simulate a running environment of the sub-application through the simulator of the first application development platform, to run the sub-application generated based on the sub-application page template of the configuration region and the added component, to display the simulated interaction page of the sub-application in the simulator region.

In one embodiment, the developer may perform an interaction operation on the simulated interaction page, to test the generated sub-application.

In this embodiment, the toolbar region and the simulator region that are provided by the first application development platform, and the configuration region configured for configuring the sub-application of the second application development platform can be displayed on the first application debugging interface of the first application development platform, so that a developer can directly use a function of another development platform on the first application development platform, and the used function can still be implemented by the another development platform. Therefore, a service provided by the second application development platform can be combined with the first application development platform. This greatly enhances a sub-application development capability of the first application development platform.

In one embodiment, a preview control is displayed in the toolbar region. The method further includes:

displaying a first graphic code of the sub-application in the simulator region in response to a trigger operation on the preview control, the first graphic code being configured for being scanned by a parent application run in a scanning terminal, to instruct the parent application run in the scanning terminal to run the sub-application, and display a preview interaction page of the sub-application.

Specifically, the preview control is displayed in the toolbar region. The preview control is configured for triggering preview of an interaction page of the sub-application.

The terminal adds, in response to the component selection operation performed by the developer on the plurality of sub-application components, the sub-application component selected by the component selection operation into the sub-application page template. The terminal generates, through the second application development platform, the sub-application based on the sub-application page template and the sub-application component that has been added into the sub-application page template.

The terminal generates the first graphic code of the sub-application through the first application development platform. When the developer triggers the preview control displayed in the toolbar region, the terminal displays the first graphic code of the sub-application in the simulator region in response to the trigger operation on the preview control.

The developer can scan the first graphic code through a parent application run in another terminal, to run the sub-application through the parent application run in the scanning terminal that scans the first graphic code, and display the preview interaction page of the sub-application. The preview interaction page is a page of the sub-application in a previewed state.

In this embodiment, the preview interaction page does not support an interaction operation. That is, the preview interaction page can only support viewing, but cannot support operations.

In this embodiment, the first graphic code of the sub-application is displayed in the simulator region in response to the trigger operation on the preview control, so that when the first graphic code is scanned, the sub-application is run through the parent application run in the scanning terminal that scans the first graphic code, and the preview interaction page of the sub-application is displayed, so that the generated sub-application can be run and previewed on another terminal, thereby ensuring that the sub-application can be run in a real machine, and presenting an effect of running the sub-application in the real machine.

In one embodiment, a real-machine debugging control is displayed in the toolbar region. The method further includes:

displaying a second graphic code of the sub-application in the simulator region in response to a trigger operation on the real-machine debugging control, the second graphic code being configured for being scanned by the parent application run in the scanning terminal, to instruct the parent application run in the scanning terminal to run the sub-application, and display an interaction page of the sub-application and a running log of the sub-application.

Specifically, the real-machine debugging control is displayed in the toolbar region. The terminal adds, in response to the component selection operation performed by the developer on the plurality of sub-application components, the sub-application component selected by the component selection operation into the sub-application page template. The terminal generates, through the second application development platform, the sub-application based on the sub-application page template and the sub-application component that has been added into the sub-application page template.

The terminal generates the second graphic code of the sub-application through the first application development platform. When the developer triggers the real-machine debugging control displayed in the toolbar region, the terminal displays the second graphic code of the sub-application in the simulator region in response to the trigger operation performed by the developer on the real-machine debugging control.

The developer can scan the second graphic code through a parent application run in another terminal, to run the sub-application through the parent application run in the scanning terminal that scans the second graphic code, and display the interaction page of the sub-application. The interaction page supports an interaction operation. The developer may perform an operation on the interaction page, to test a related function in the interaction page.

In addition, the running log of the sub-application is further displayed through the parent application run in the scanning terminal that scans the second graphic code, so that the developer can test a related function of the generated sub-application in a real machine, and can view the running log of the sub-application.

In this embodiment, by running the sub-application through the parent application run in the scanning terminal that scans the second graphic code and displaying the interaction page of the sub-application, the developer can perform the interaction operation on the interaction page, and generate an operation record based on the interaction operation, to generate the running log of the sub-application.

In this embodiment, the second graphic code of the sub-application is displayed in the simulator region in response to the trigger operation on the real-machine debugging control, so that when the second graphic code is scanned, the sub-application is run through the parent application run in the scanning terminal that scans the second graphic code, thereby running the sub-application in the real machine, to present an effect of running the sub-application in the real machine. In addition, the interaction page of the sub-application and the running log of the sub-application are displayed, so that a related function of the sub-application can be tested in the real machine, and it is convenient for the developer to directly view the running log of the sub-application in the real machine, thereby enhancing sub-application debugging efficiency.

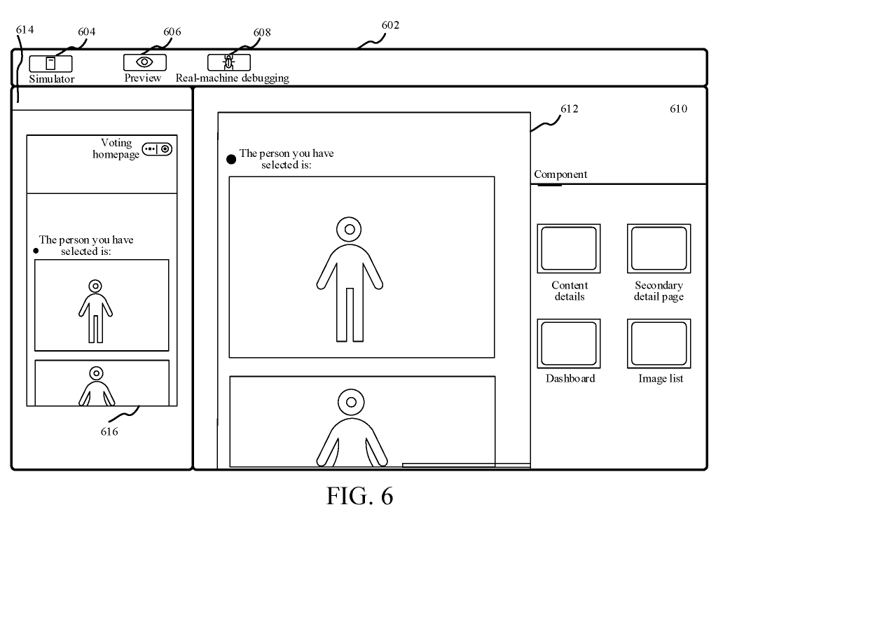

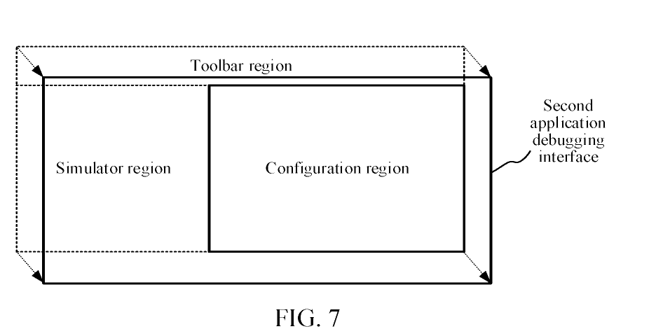

In one embodiment, as shown in FIG. 6, a toolbar region 602 displays a simulator trigger control 604, a preview control 606, and a real-machine debugging control 608. After a configuration region 610 is added into a sub-application page template 612, the developer may trigger the simulator trigger control 604, and display a simulated interaction page 616 of a sub-application in a simulator region 614.

When the developer triggers the preview control, a first graphic code of the sub-application is displayed in the simulator region. The first graphic code is configured for being scanned by a parent application run in a scanning terminal, to instruct the parent application run in the scanning terminal to run the sub-application, and a preview interaction page of the sub-application is displayed.

When the developer triggers the real-machine debugging control, a second graphic code of the sub-application is displayed in the simulator region. The second graphic code is configured for being scanned by the parent application run in the scanning terminal, to instruct the parent application run in the scanning terminal to run the sub-application, and an interaction page of the sub-application and a running log of the sub-application are displayed.

In one embodiment, the displaying, in response to an identifier selection operation on the template identifier, a simulator region of the first application development platform and a configuration region configured for configuring a sub-application of the second application development platform includes:

displaying, in response to the identifier selection operation on the template identifier, the simulator region of the first application development platform, and displaying a second application debugging interface overlaying the simulator region. The second application debugging interface includes the configuration region configured for configuring the sub-application of the second application development platform and an interaction region except the configuration region, and an operation in the interaction region can act on the simulator region.

Specifically, the terminal determines, in response to the identifier selection operation performed by the developer on the template identifier, the template identifier selected by the identifier selection operation, and determines the sub-application page template represented by the selected template identifier. The template identifier and the sub-application page template are provided by the second application development platform.

The terminal displays the simulator region of the first application development platform, and displays the second application debugging interface overlaying the simulator region. The second application debugging interface is provided by the second application development platform.

The second application debugging interface includes the configuration region configured for configuring the sub-application of the second application development platform. The terminal displays, in the configuration region, the sub-application page template provided by the second application development platform, and displays the plurality of sub-application components provided by the second application development platform.

A region, except the configuration region, on the second application debugging interface is used as the interaction region. Since the second application debugging interface overlays the simulator region, when the developer is to operate the simulator region, the operation may be performed on the interaction region. That is, the operation performed by the developer on the interaction region can act on the simulator region.

In this embodiment, the interaction region overlays the simulator region provided by the first application development platform. The simulator region is at a lower layer of the interaction region and can be displayed through the interaction region. For example, the interaction region is a transparent region. The interaction region overlays the simulator region, so that the simulator region can be displayed through the interaction region, and the operation performed by the developer on the interaction region can act on a corresponding position of the simulator region.

In this embodiment, as shown in FIG. 7, in response to the identifier selection operation on the template identifier, a native debugging region of the first application development platform is displayed, and the second application debugging interface overlaying the native debugging region is displayed. The native debugging region includes the simulator region and the toolbar region of the first application development platform. The second application debugging interface includes the configuration region configured for configuring the sub-application of the second application development platform and the interaction region except the configuration region. The operation on the interaction region can act on the native debugging region. The interaction region overlays the native debugging region of the first application development platform. The native debugging region is at the lower layer of the interaction region and can be displayed through the interaction region, so that the operation performed by the developer on the interaction region can act on a corresponding position of the native debugging region.

In this embodiment, in response to the identifier selection operation on the template identifier, the simulator region of the first application development platform is displayed, and the second application debugging interface overlaying the simulator region is displayed. In addition, the second application debugging interface includes the configuration region configured for configuring the sub-application of the second application development platform and the interaction region except the configuration region, so that a degree of freedom of displaying of the configuration region is higher. The operation on the interaction region can act on the simulator region, so that the simulator region can be operated from the interaction region, and configuration in the configuration region and the operation on the simulator region can be implemented on the same interface, thereby effectively expanding functions of the first application development platform. Interface displaying is more flexible and requirements of different users can be met.

In one embodiment, the displaying, in response to an identifier selection operation on the template identifier, a simulator region of the first application development platform and a configuration region configured for configuring a sub-application of the second application development platform includes:

obtaining, in response to the identifier selection operation on the template identifier, a template plug-in that is bound to the template identifier and is provided by the second application development platform; and determining a plug-in configuration file of the template plug-in, and determining an interface rendering manner based on the plug-in configuration file; and displaying, based on the interface rendering manner, the simulator region of the first application development platform and the configuration region configured for configuring the sub-application of the second application development platform.

The interface rendering manner includes embedded rendering and overlay rendering. The embedded rendering means that the configuration region configured for configuring the sub-application of the second application development platform is embedded in the first application debugging interface of the first application development platform. That is, the embedded rendering indicates that the configuration region configured for configuring the sub-application of the second application development platform and the simulator region of the first application development platform are both embedded in the first application debugging interface of the first application development platform.

When the first application development platform provides the toolbar region, the embedded rendering indicates that the configuration region configured for configuring the sub-application of the second application development platform and the toolbar region, as well as the simulator region of the first application development platform, are embedded in the first application debugging interface of the first application development platform.

The overlay rendering means that the second application debugging interface provided by the second application development platform overlays the simulator region provided by the first application development platform, and the second application debugging interface includes the configuration region.

When the first application development platform provides the toolbar region, the overlay rendering indicates that the second application debugging interface provided by the second application development platform overlays the simulator region and the toolbar region that are provided by the first application development platform.

The template plug-in is a program compiled by an application programming interface that follows a specification. The template plug-in is defined and compiled by the first application development platform.

Specifically, the terminal determines, in response to the identifier selection operation performed by the developer on the template identifier, the template identifier selected by the identifier selection operation, and determines the template plug-in that is bound to the template identifier and is provided by the second application development platform. The terminal determines the plug-in configuration file of the template plug-in. The plug-in configuration file defines the interface rendering manner provided by the second application development platform. The terminal determines the interface rendering manner from the plug-in configuration file. The terminal performs interface rendering based on the interface rendering manner, to obtain the simulator region of the first application development platform and the configuration region configured for configuring the sub-application of the second application development platform. The terminal displays the simulator region of the first application development platform and the configuration region configured for configuring the sub-application of the second application development platform.

In this embodiment, the template plug-in that is bound to the template identifier and is provided by the second application development platform is obtained in response to the identifier selection operation on the template identifier, to determine the interface rendering manner based on the plug-in configuration file of the template plug-in, so that the simulator region of the first application development platform and the configuration region configured for configuring the sub-application of the second application development platform can be automatically rendered based on the interface rendering manner defined by the second application development platform.

In one embodiment, the displaying, based on the interface rendering manner, the simulator region of the first application development platform and the configuration region configured for configuring the sub-application of the second application development platform includes:

displaying the first application debugging interface of the first application development platform when the interface rendering manner is embedded rendering, the first application debugging interface including the simulator region of the first application development platform and the configuration region configured for configuring the sub-application of the second application development platform; and when the interface rendering manner is overlay rendering, displaying the simulator region of the first application development platform, and displaying the second application debugging interface overlaying the simulator region, the second application debugging interface including the configuration region configured for configuring the sub-application of the second application development platform.

Specifically, when the interface rendering manner is the embedded rendering, the terminal generates the first application debugging interface of the first application development platform, and displays, on the first application debugging interface, the simulator region of the first application development platform and the configuration region configured for configuring the sub-application of the second application development platform. Further, the first application debugging interface includes the simulator region and the toolbar region of the first application development platform, and the configuration region configured for configuring the sub-application of the second application development platform.

When the interface rendering manner is the overlay rendering, the terminal displays the simulator region of the first application development platform, and displays the second application debugging interface that overlays the simulator region and is provided by the first application development platform. The second application debugging interface includes the configuration region configured for configuring the sub-application of the second application development platform. Further, the second application debugging interface overlays the simulator region and the toolbar region of the first application development platform.

In this embodiment, when the interface rendering manner is the embedded rendering, the first application debugging interface of the first application development platform is displayed. The first application debugging interface includes a native debugging region of the first application development platform and the configuration region configured for configuring the sub-application of the second application development platform, and the native debugging region includes the simulator region and the toolbar region. When the interface rendering manner is the overlay rendering, the native debugging region of the first application development platform is displayed, and the second application debugging interface overlaying the native debugging region is displayed. The second application debugging interface includes the configuration region configured for configuring the sub-application of the second application development platform.

In this embodiment, two interface rendering manners defined by the second application development platform are provided, so that the simulator region and the configuration region can be automatically rendered on the first application development platform based on the interface rendering manners defined by the second application development platform. When the interface rendering manner is the embedded rendering, the simulator region of the first application development platform and the configuration region configured for configuring the sub-application of the second application development platform are rendered to be displayed on the same interface, so that it is convenient for the developer to view and configure the interaction page of the generated sub-application while performing page configuration. When the interface rendering manner is the overlay rendering, the simulator region of the first application development platform is displayed, and the second application debugging interface overlaying the simulator region is displayed. The second application debugging interface includes the configuration region configured for configuring the sub-application of the second application development platform, so that the degree of freedom of displaying of the configuration region is higher, and content in the configuration region can be displayed more completely. This facilitates operations of the developer.

In one embodiment, the method further includes:

obtaining first layout information of the simulator region of the first application development platform when the interface rendering manner is the embedded rendering; determining, based on the first layout information of the simulator region, second layout information of the configuration region configured for configuring the sub-application of the second application development platform; and generating the first application debugging interface of the first application development platform based on the second layout information and the first layout information.

The first layout information refers to information related to a layout of the simulator region of the first application development platform, and includes a display position, a display size, and the like of the simulator region. The second layout information refers to information related to a layout of the configuration region configured for configuring the sub-application of the second application development platform, and includes a display position, a display size, and the like of the configuration region.

Specifically, when the interface rendering manner is the embedded rendering, the terminal may obtain the first layout information of the simulator region provided by the first application development platform. The terminal may obtain, from the second application development platform, original layout information of the configuration region configured for configuring the sub-application of the second application development platform, and determine the second layout information of the configuration region based on the first layout information of the simulator region and the original layout information.

The original layout information of the configuration region refers to layout information of the configuration region configured for configuring the sub-application of the second application development platform. The second layout information of the configuration region is layout information formed after the original layout information is adjusted based on the first layout information.

The terminal generates the first application debugging interface of the first application development platform based on the second layout information and the first layout information.

In this embodiment, the terminal transmits the second layout information and the first layout information to a first server corresponding to the first application development platform. Through the first server, the first application debugging interface of the first application development platform is generated based on the second layout information and the first layout information.

In this embodiment, the terminal transmits the first layout information and the original layout information to the first server corresponding to the first application development platform, and adjusts the original layout information based on the first layout information through the first server to obtain the second layout information. Through the first server, the first application debugging interface is generated based on the second layout information and the first layout information.

In one embodiment, when the interface rendering manner is the embedded rendering, first layout information of the simulator region of the first application development platform and third layout information of the toolbar region are obtained; second layout information of the configuration region configured for configuring the sub-application of the second application development platform is determined based on the first layout information of the simulator region and the third layout information of the toolbar region; and the first application debugging interface of the first application development platform is generated based on the first layout information, the second layout information, and the third layout information, so that the first application debugging interface can accommodate the simulator region, the toolbar region, and the configuration region.

Further, the terminal transmits the first layout information, the second layout information, and the third layout information to a first server corresponding to the first application development platform. Through the first server, the first application debugging interface of the first application development platform is generated based on the first layout information, the second layout information, and the third layout information.

In this embodiment, when the interface rendering manner is the embedded rendering, the first layout information of the simulator region of the first application development platform is obtained, and the second layout information of the configuration region configured for configuring the sub-application of the second application development platform is determined based on the first layout information of the simulator region, to accurately generate, based on the second layout information and the first layout information, the first application debugging interface into which the simulator region and the configuration region are embedded.

In one embodiment, the when the interface rendering manner is overlay rendering, displaying the simulator region of the first application development platform, and displaying the second application debugging interface overlaying the simulator region includes:

obtaining first layout information of the simulator region of the first application development platform when the interface rendering manner is the overlay rendering; determining, based on the first layout information of the simulator region, second layout information of the configuration region configured for configuring the sub-application of the second application development platform; obtaining, based on the second layout information and the first layout information, the second application debugging interface provided by the second application development platform, the second application debugging interface including the configuration region and the interaction region; and displaying the second application debugging interface, and displaying the simulator region overlaid by the interaction region of the second application debugging interface, a layout of the simulator region being displayed in the interaction region.

Specifically, when the interface rendering manner is the overlay rendering, the terminal obtains the first layout information of the simulator region of the first application development platform. The terminal may obtain, from the second application development platform, original layout information of the configuration region configured for configuring the sub-application of the second application development platform, and determine the second layout information of the configuration region based on the first layout information of the simulator region and the original layout information. The terminal may transmit the second layout information and the first layout information to a second server corresponding to the second application development platform, and generate the second application debugging interface of the second application development platform based on the second layout information and the first layout information through the second server. The second application debugging interface includes a configuration region and the interaction region except the configuration region.

The terminal displays the second application debugging interface, and displays the simulator region overlaid by the interaction region of the second application debugging interface. The layout of the simulator region is displayed through the interaction region. That is, the simulator region is at a lower layer of the interaction region and may be displayed through the interaction region.

In this embodiment, the when the interface rendering manner is overlay rendering, displaying the simulator region of the first application development platform, and displaying the second application debugging interface overlaying the simulator region includes:

when the interface rendering manner is the overlay rendering, transmitting the first layout information of the simulator region of the first application development platform to the second server corresponding to the second application development platform, the first layout information being configured for instructing the second server to determine the second layout information of the configuration region and generate the second application debugging interface based on the second layout information and the first layout information; and

displaying the simulator region of the first application development platform, and displaying the second application debugging interface overlaying the simulator region, the simulator region being at the lower layer of the interaction region and being displayed through the interaction region.

In one embodiment, the developer may perform an operation on the configuration region of the second application debugging interface, so that the performed operation can be directly act on the configuration region. The developer may perform an operation on the interaction region of the second application debugging interface, so that the performed operation can act on the simulator region.

In this embodiment, when the interface rendering manner is the overlay rendering, the first layout information of the simulator region of the first application development platform is obtained, and the second layout information of the configuration region configured for configuring the sub-application of the second application development platform is determined based on the first layout information of the simulator region. The second application debugging interface including the configuration region and the interaction region is obtained based on the second layout information and the first layout information, so that when the second application debugging interface and the simulator region are displayed, the simulator region overlaid by the interaction region of the second application debugging interface can be displayed through the interaction region, and the developer can see the displayed simulated interaction page in the overlaid simulator region.

In one embodiment, the method further includes: adjusting, when a first preset operation in the configuration region is detected, a view hierarchy of the second application debugging interface to be higher than a view hierarchy of the simulator region, the second application debugging interface subjected to view hierarchy adjustment being configured for responding to the operation for the configuration region through the configuration region.

In one embodiment, the method further includes: adjusting, when a second preset operation acting on the interaction region is detected, a view hierarchy of the second application debugging interface to be lower than a view hierarchy of the simulator region, after view hierarchy adjustment, the simulator region being configured for responding to the operation for the interaction region.

Specifically, when the interface rendering manner is the overlay rendering, the second application debugging interface is displayed, and the simulator region overlaid by the interaction region of the second application debugging interface is displayed. The terminal may detect an operation of the developer. When an operation in the configuration region is detected, and the operation is the first preset operation, it indicates that the developer needs to perform a related configuration operation on the configuration region, and the terminal adjusts the view hierarchy of the second application debugging interface to be higher than the view hierarchy of the simulator region. When the view hierarchy of the second application debugging interface is higher than the view hierarchy of the simulator region, the operation performed by the developer on the configuration region can directly act on the configuration region.

When the view hierarchy of the second application debugging interface is lower than the view hierarchy of the simulator region, the operation performed by the developer on the interaction region of the second application debugging interface can act on the simulator region.

When an operation acting on the interaction region is detected, and the operation is the second preset operation, it indicates that the developer is to perform a related operation on the simulator region, and the terminal adjusts the view hierarchy of the second application debugging interface to be lower than the view hierarchy of the simulator region. After the view hierarchy of the simulator region is adjusted, in response to the operation performed by the developer on the interaction region, the operation acts on the simulator region.

Further, after the view hierarchy of the simulator region is adjusted, in response to the operation performed by the developer on the interaction region, an interaction position of the operation in the interaction region is determined, a corresponding position of the interaction position in the simulator region is determined, and the operation acts on the corresponding position in the simulator region. For example, a control A exists in the simulator region. The developer can see the control A in the simulator region via the interaction region. The developer taps/clicks a position a in the interaction region. The position a is a position of the control A seen by the developer in the interaction region. Then, the terminal applies the tap/click operation to the control A in the simulator region, and executes a function corresponding to the control A.

In this embodiment, the method further includes:

adjusting, when the first preset operation in the configuration region is detected, the view hierarchy of the second application debugging interface to be higher than a view hierarchy of the native debugging region, such that after view hierarchy adjustment, the operation on the configuration region can act on the configuration region; and adjusting, when the second preset operation acting on the interaction region is detected, the view hierarchy of the second application debugging interface to be lower than the view hierarchy of the native debugging region, such that after view hierarchy adjustment, the operation on the interaction region can act on the native debugging region. The native debugging region includes the simulator region and the toolbar region.

For example, to enable the developer to operate the native debugging region and the configuration region at the same time, when the mouse is moved to the configuration region, the view hierarchy of the second application debugging interface can be automatically moved to the topmost layer. In this case, a plug-in needs to automatically detect a mouse event. When the mouse is moved into the interaction region, a preset interface provided by the first application development platform is invoked to lower the view hierarchy of the second application debugging interface, so that an operation event in the interaction region can penetrate through the interaction region and act on the native debugging region. In this way, the developer can also normally tap/click a related control in the native debugging region.

In this embodiment, when the first preset operation in the configuration region is detected, it indicates that the developer needs to perform a related configuration operation on the configuration region, and the view hierarchy of the second application debugging interface is adjusted to be higher than the view hierarchy of the simulator region, so that after the view hierarchy adjustment, the developer can directly perform the operation on the configuration region. When the second preset operation acting on the interaction region is detected, it indicates that the developer is to perform a related operation on the simulator region, and the view hierarchy of the second application debugging interface is adjusted to be lower than the view hierarchy of the simulator region, so that after the view hierarchy adjustment, the operation performed by the developer on the interaction region can act on the simulator region. In a case that the second application debugging interface overlays the simulator region, the developer can still normally use a function of the simulator region. In this embodiment, by automatically adjusting the view hierarchy to adapt to the operation of the developer, efficiency of generating sub-applications is further enhanced.

In one embodiment, the method further includes:

running a built-in project creation script of the template plug-in, to obtain a sub-application project identifier; locally creating a sub-application development project on the first application development platform based on the sub-application project identifier; and generating, based on the sub-application development project, the simulator region of the first application development platform and the configuration region configured for configuring the sub-application of the second application development platform.

Specifically, the terminal determines, in response to the identifier selection operation performed by the developer on the template identifier, the template identifier selected by the identifier selection operation, and determines the template plug-in that is bound to the template identifier and is provided by the second application development platform. The terminal determines the built-in project creation script of the template plug-in, and loads and runs the project creation script to obtain the sub-application project identifier. The terminal locally automatically creates the sub-application development project on the first application development platform based on the sub-application project identifier, and may generate, after the creation is completed, the simulator region of the first application development platform and the configuration region configured for configuring the sub-application of the second application development platform.

The terminal determines the interface rendering manner based on the plug-in configuration file, and displays the simulator region and the configuration region based on the interface rendering manner.

In this embodiment, a project creation region is displayed on the sub-application development interface. The terminal locally automatically creates the sub-application development project on the first application development platform based on the sub-application project identifier, generates project information of the sub-application development project, and automatically fills the project creation region with the generated project information.

In this embodiment, the sub-application project identifier may be obtained by running the built-in project creation script of the template plug-in, and the sub-application development project is locally created on the first application development platform based on the sub-application project identifier, so that a function of a customized project creation logic of the second application development platform can be provided and used on the first application development platform. Thus, the simulator region of the first application development platform and the configuration region configured for configuring the sub-application of the second application development platform are generated based on the sub-application development project, to implement combination of a debugging function of the first application development platform and a configuration function of the second application development platform.

In one embodiment, the method further includes:

obtaining a sub-application code from the second application development platform based on the template plug-in, the sub-application code being generated based on the sub-application page template and the sub-application component that has been added into the sub-application page template; and locally storing the sub-application code and running the sub-application code, to obtain the simulated interaction page of the sub-application.

Specifically, the second application development platform generates the sub-application code based on the sub-application page template and the sub-application component that has been added into the sub-application page template, and the terminal obtains the sub-application code based on the template plug-in provided by the second application development platform.

The terminal locally stores the sub-application code to the first application development platform, and runs the locally stored sub-application code, to generate the sub-application and the simulated interaction page of the sub-application. The terminal displays the simulated interaction page of the sub-application in the simulator region in response to the simulation trigger event for the simulator region.

In this embodiment, in response to the trigger operation on the simulator trigger control in the toolbar region, the terminal runs the locally stored sub-application code through the simulator of the first application development platform, to obtain the sub-application and the simulated interaction page of the sub-application, and displays the simulated interaction page of the sub-application in the simulator region.

In this embodiment, when the developer adjusts, in the configuration region, the added component in the sub-application page template, the second application development platform may generate an updated sub-application code based on an adjusted added component in the sub-application page template. The terminal obtains the updated sub-application code through the template plug-in, to update the sub-application code locally stored on the first application development platform, thus displaying a simulated interaction page of an updated sub-application in the simulator region.

In this embodiment, the obtaining a sub-application code from the second application development platform based on the template plug-in includes:

invoking a preset interface provided by the first application development platform; and obtaining the sub-application code from the second application development platform based on the template plug-in through the preset interface.

In this embodiment, the second application development platform may generate the sub-application code based on the sub-application page template and the sub-application component that has been added into the sub-application page template, so that the developer can use, on the first application development platform, a page template and a component that are defined by the second application development platform, and can still generate a sub-application code using an original generation logic of the second application development platform, without modifying the generation logic of the sub-application code. The sub-application code may be obtained from the second application development platform through the template plug-in, so as to be locally stored to the first application development platform and run, to obtain the simulated interaction page of the sub-application, thereby effectively expanding the development capability of the first application development platform based on the template plug-in and enabling the first application development platform to be compatible with development logics of different development platforms.

In one embodiment, the displaying, on the sub-application development interface, a template identifier of a sub-application page template provided by a second application development platform includes:

displaying at least one platform identifier each corresponding to one second application development platform on the sub-application development interface; and displaying, on the sub-application development interface in response to an identifier selection operation of selecting from the at least one platform identifier, a template identifier associated with a selected platform identifier, the template identifier being configured for identifying a sub-application page template provided by a second application development platform with the selected platform identifier.

The platform identifier is configured for identifying the second application development platform. The platform identifier is associated with the template identifier, to indicate that the sub-application page template represented by the template identifier is provided by the second application development platform represented by the platform identifier. That is, the template identifier of the sub-application page template provided by the second application development platform is associated with the platform identifier of the second application development platform.

Specifically, the terminal displays the platform identifier of the at least one second application development platform on the sub-application development interface. The developer may perform selection from among the platform identifier of the at least one second application development platform. In response to the identifier selection operation performed by the developer, the terminal determines the platform identifier selected by the identifier selection operation. The terminal determines the second application development platform represented by the platform identifier, and obtains the template identifier of the sub-application page template provided by the second application development platform. The terminal displays the obtained template identifier on the sub-application development interface.

In this embodiment, the terminal obtains, through the first application development platform, the template identifier of the sub-application page template from the second application development platform identified by the platform identifier.

In this embodiment, the terminal displays a platform selection trigger control on the sub-application development interface, and displays the platform identifier of the at least one second application development platform on the sub-application development interface in response to a trigger operation performed by the developer on the platform selection trigger control.

In this embodiment, the platform identifier of the at least one second application development platform is displayed on the sub-application development interface, so that the at least one third-party application development platform can be provided for selection by the developer, and the developer can generate, directly on the first application development platform, a sub-application using a page template and a component that are provided by another application development platform. In response to the identifier selection operation of selecting from at least one platform identifier, the template identifier associated with the selected platform identifier is displayed on the sub-application development interface. The template identifier is configured for identifying the sub-application page template provided by the second application development platform with the selected platform identifier, so that page templates provided by the second application development platform selected by a user can be displayed for selection by the user, to meet different requirements of the user.

In one embodiment, the method further includes:

displaying a template type trigger control on the sub-application development interface; and displaying at least one candidate template type on the sub-application development interface in response to a trigger operation on the template type trigger control.

The displaying, on the sub-application development interface in response to an identifier selection operation of selecting from the at least one platform identifier, a template identifier associated with a selected platform identifier includes:

displaying, on the sub-application development interface in response to an identifier selection operation of selecting from the at least one platform identifier and a type selection operation of selecting from the at least one candidate template type, the template identifier that belongs to a selected template type and is associated with the selected platform identifier.

A candidate template type refers to a type of a sub-application page template, and different types of sub-applications may be generated through different types of sub-application page templates.

Specifically, the terminal displays the platform identifier of the at least one second application development platform on the sub-application development interface, and displays the template type trigger control on the sub-application development interface. The developer may perform selection from among the platform identifier of the at least one second application development platform. In response to the identifier selection operation of the developer, the terminal determines the platform identifier selected by the identifier selection operation, and determines the second application development platform represented by the platform identifier.

The developer may trigger the template type trigger control, and the terminal displays the at least one candidate template type on the sub-application development interface in response to the trigger operation performed by the developer on the template type trigger control.

The developer may select at least one type from among displayed candidate template types, and the terminal obtains, from the second application development platform in response to the type selection operation of the developer, each template identifier belonging to a target template type selected by the type selection operation.

In this embodiment, the method further includes: displaying, in the configuration region, a sub-application page template and a plurality of sub-application components bound to a template type to which the sub-application page template belongs. The plurality of sub-application components are provided by the second application development platform.

In this embodiment, the template type trigger control is displayed on the sub-application development interface, and in response to the trigger operation on the template type trigger control, the at least one candidate template type is displayed on the sub-application development interface, so that the developer can be provided with types of page templates of another development platform on the first application development platform; the page templates of the another development platform can be classified in more detail; and the developer can flexibly select a corresponding template type based on a type of a sub-application that needs to be generated by the developer. Thus, page templates of the another development platform in this type are displayed for flexible selection by the developer.

In one embodiment, the displaying a platform identifier of at least one second application development platform on the sub-application development interface includes:

displaying a platform type trigger control on the sub-application development interface; displaying at least one platform type on the sub-application development interface in response to a trigger operation on the platform type trigger control; and displaying, on the sub-application development interface in response to a type selection operation of selecting from the at least one platform type, a platform identifier of at least one second application development platform belonging to a selected platform type.

A platform type refers to a type of a second application development platform. Different types of development platforms may generate different types of sub-applications. For example, a map application development platform can generate a map sub-application, and a voting application development platform can generate a voting sub-application.

Specifically, the terminal displays the sub-application development interface of the first application development platform, and displays the platform type trigger control on the sub-application development interface. The developer may trigger the control to view different types of second application development platforms. The terminal displays the at least one platform type on the sub-application development interface in response to the trigger operation on the platform type trigger control, and the developer may select at least one type from among displayed platform types. The terminal determines, in response to the type selection operation performed by the developer on the at least one platform type, a platform type selected by the type selection operation, and determines platform identifiers of second application development platforms belonging to the platform type. The terminal displays, on the sub-application development interface, the platform identifier of at least one second application development platform belonging to the selected platform type.

In this embodiment, the first application development platform displays platform types of different types of second application development platforms on an interface for selection by the developer, so that the different types of second application development platforms can be invoked on the first application development platform, and the different types of second application development platforms can be combined into the first application development platform, to provide a more comprehensive development function for the developer. Any type of sub-application that needs to be generated by the developer can be generated through the first application development platform, without using a particular type of application development platform. This can enhance flexibility and convenience of sub-application development.

In one embodiment, a sub-application generation method is provided, which is applied to a terminal and includes:

displaying a sub-application development interface of a first application development platform, and displaying a platform identifier of at least one second application development platform and a template type trigger control on the sub-application development interface;

next, displaying at least one candidate template type on the sub-application development interface in response to a trigger operation on the template type trigger control;

further, displaying, on the sub-application development interface in response to an identifier selection operation of selecting from at least one platform identifier and a type selection operation of selecting from the at least one candidate template type, a template identifier that belongs to a selected template type and is associated with a selected platform identifier, the template identifier being configured for identifying a sub-application page template provided by a second application development platform with the selected platform identifier;

then, determining, in response to an identifier selection operation on the template identifier, a template plug-in bound to the template identifier associated with the selected platform identifier, determining a plug-in configuration file of the template plug-in, and determining an interface rendering manner based on the plug-in configuration file;

in some embodiments, displaying a first application debugging interface when the interface rendering manner is embedded rendering, the first application debugging interface including a simulator region provided by the first application development platform, a toolbar region provided by the first application development platform, and a configuration region configured for configuring a sub-application of the second application development platform; the sub-application page template and a plurality of sub-application components provided by the second application development platform being displayed in the configuration region; a simulator trigger control, a preview control, and a real-machine debugging control being displayed in the toolbar region;

in some embodiments, displaying a native debugging region of the first application development platform when the interface rendering manner is overlay rendering, and displaying a second application debugging interface overlaying the native debugging region, the second application debugging interface including the configuration region configured for configuring the sub-application of the second application development platform and an interaction region except the configuration region, an operation on the interaction region being able to act on the native debugging region, and the native debugging region including the toolbar region and the simulator region;

next, adding, in response to a component selection operation of selecting from the plurality of sub-application components, a sub-application component selected by the component selection operation into the sub-application page template;

further, displaying, in response to a trigger operation on the simulator trigger control, a simulated interaction page of the sub-application in the simulator region, the simulated interaction page being generated based on the sub-application page template and the sub-application component that has been added into the sub-application page template;

further, displaying a first graphic code of the sub-application in the simulator region in response to a trigger operation on the preview control, the first graphic code being configured for being scanned by a parent application run in a scanning terminal, to instruct the parent application run in the scanning terminal to run the sub-application, and display a preview interaction page of the sub-application; and

further, displaying a second graphic code of the sub-application in the simulator region in response to a trigger operation on the real-machine debugging control, the second graphic code being configured for being scanned by the parent application run in the scanning terminal, to instruct the parent application run in the scanning terminal to run the sub-application, and display an interaction page of the sub-application and a running log of the sub-application.

In this embodiment, the sub-application development interface of the first application development platform is displayed, to display platform identifiers of a plurality of second application development platforms and various candidate template types on the sub-application development interface of the first application development platform, so that a plurality of other selectable application development platforms and various types of selectable page templates are provided on the first application development platform. Thus, the first application development platform and the second application development platforms can be combined, so that a user can select and use, on the first application development platform, page templates provided by the second application development platforms to generate sub-applications. After selecting a desired second application development platform and the sub-application page template provided by the second application development platform, the developer can determine the interface rendering manner through the template plug-in bound to the template identifier, to determine an interface display manner.

When the interface rendering manner is the embedded rendering, the simulator region of the first application development platform and the configuration region configured for configuring the sub-application of the second application development platform are rendered to be displayed on the same interface, so that it is convenient for the developer to view and configure the interaction page of the generated sub-application while performing page configuration. When the interface rendering manner is the overlay rendering, the simulator region of the first application development platform is displayed, and the second application debugging interface overlaying the simulator region is displayed. The second application debugging interface includes the configuration region configured for configuring the sub-application of the second application development platform, so that the degree of freedom of displaying of the configuration region is higher, and content in the configuration region can be displayed more completely. This facilitates operations of the developer.

The sub-application page template provided by the second application development platform and the plurality of sub-application components provided by the second application development platform are displayed in the configuration region configured for configuring the sub-application of the second application development platform. These page templates and components are provided by the second application development platform and are decoupled from the first application development platform itself, so that the user can freely invoke a page template and component of a third-party application development platform. In response to the component selection operation of selection among from the plurality of sub-application components, the sub-application component selected by the component selection operation is added into the sub-application page template. In response to the simulation trigger event for the simulator region, the simulated interaction page of the sub-application is displayed in the simulator region. The simulated interaction page is generated based on the sub-application page template and the sub-application component that has been added into the sub-application page template. These page templates and components are provided by the second application development platform and are decoupled from the first application development platform itself, thereby expanding a sub-application development function through the first application development platform. In addition, the sub-application can be generated through visualized component selection, and a user does not need to write codes, so that a user that does not understand codes can also generate a customized sub-application, thereby making sub-application development easier and enhancing sub-application development efficiency.

In one embodiment, an application scene of a sub-application generation method is provided. A processing process is as follows:

A first application development platform may be a developer tool. A second application development platform may be a third-party service provider. The third-party service provider refers to another development tool except the developer tool. A sub-application is a mini program.

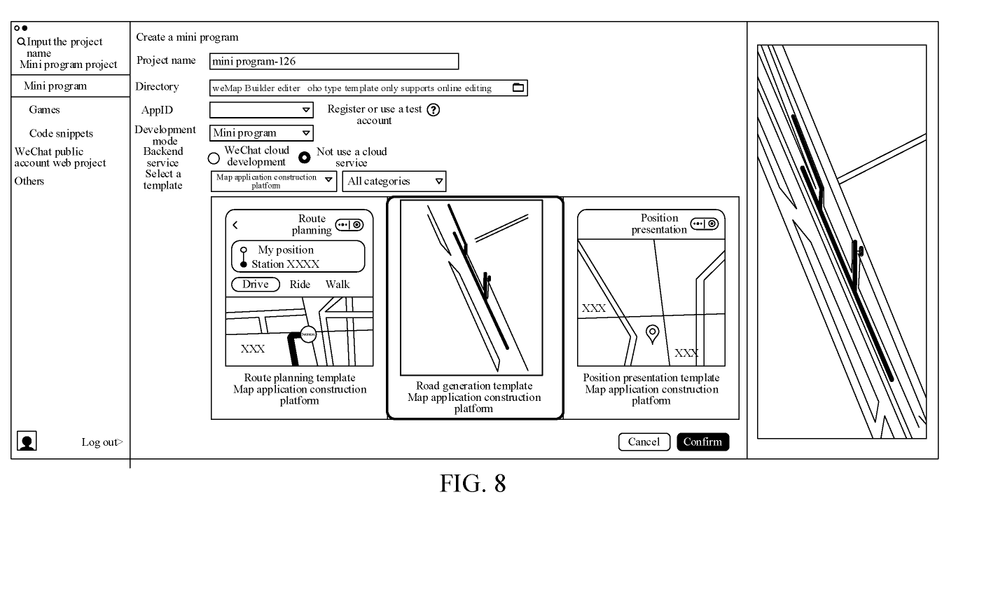

As shown in FIG. 8, a template identifier of a third-party service provider is added into a project list page of the developer tool, and the template identifier is displayed as a part of content of a sub-application page template. The project list page is a sub-application development interface. When a developer taps/clicks the template identifier, the sub-application page template identified by the tapped/clicked template identifier is displayed on the sub-application development interface.

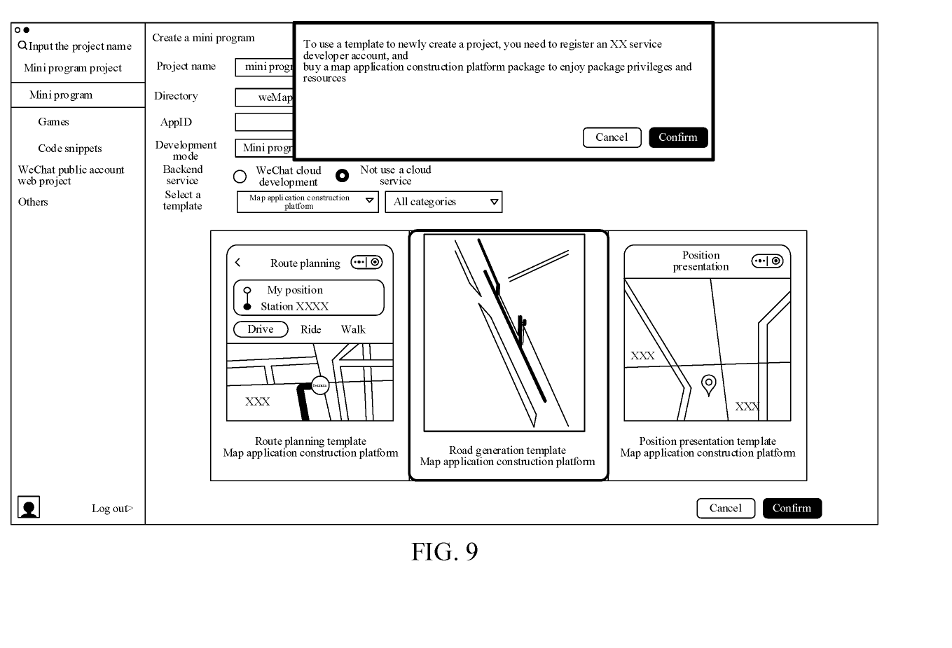

After selecting the template identifier, the developer taps/clicks a confirm control to complete selection, and then a project creation logic customized by the third-party service provider is executed, as shown in FIG. 9.

After a project is successfully created, a first application debugging interface is displayed. As shown in FIG. 6, this interface is mainly divided into three parts. A simulator region is shown on the left, and a toolbar region is shown on the top. They are native functions of the developer tool. An interface, i.e. a configuration region, customized by the third-party service provider is shown on the right.

After selecting a related component from the configuration region on the right, the developer may directly debug an application programming interface (API) in the simulator region on the left. The API is a preset interface, which is some predefined functions, to provide an ability for an application program and the developer to access a group of routines based on software or hardware, without accessing source codes or understanding details of an internal working mechanism.

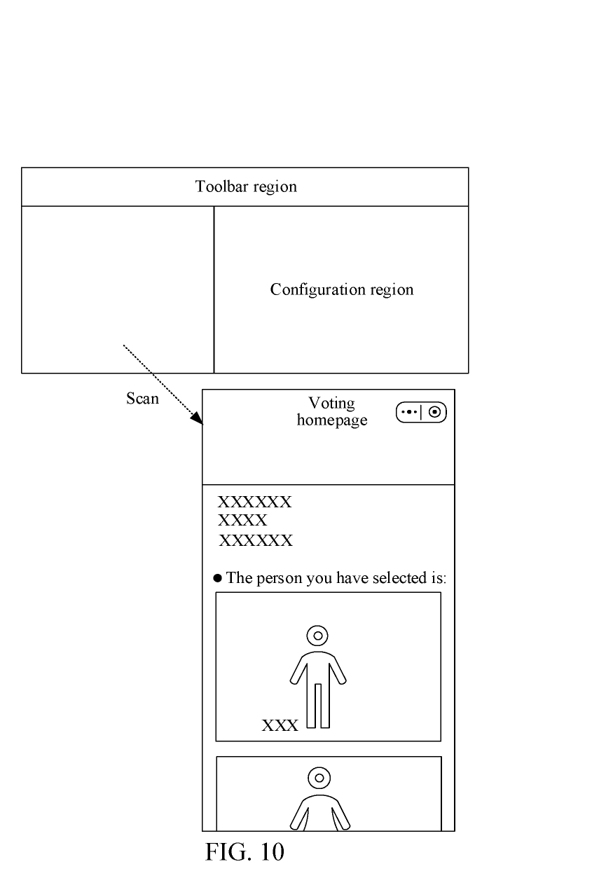

In addition, the developer may remotely debug the mini program using a real-machine debugging function in the toolbar region. Specifically, the mini program may be displayed in the simulator region by tapping/clicking a save control in the toolbar region, or the mini program may be displayed in the simulator region by tapping/clicking a "simulator" control. The preview control in the toolbar region is tapped/clicked. A two-dimensional barcode corresponding to the mini program is displayed in the simulator region. A mobile phone is used to scan the two-dimensional barcode, and the mini program is displayed on the mobile phone, as shown in FIG. 10. The real-machine debugging control in the toolbar region is tapped/clicked. The two-dimensional barcode corresponding to the mini program is displayed in the simulator region. The mobile phone is used to scan the two-dimensional barcode, and the mini program and a running log of the mini program are displayed on the mobile phone.

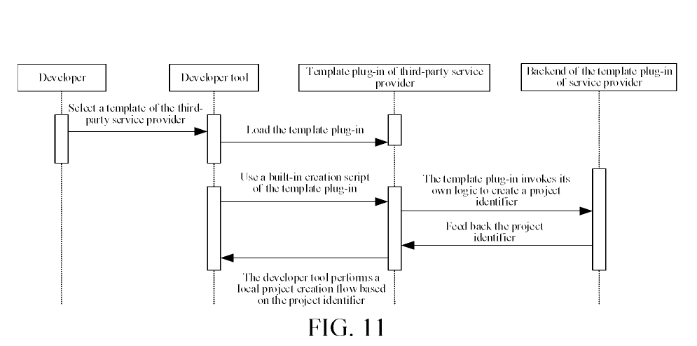

On the technical side, as shown in FIG. 11, an example in which the developer taps/clicks the template identifier that is on the project list page and is provided by a map application construction platform is used. The developer tool first reads a template plug-in that is bound to the template identifier and is provided by the third-party service provider, loads and runs a built-in project creation script in the template plug-in to create a project ID, and finally returns the project ID to the developer tool. The developer tool truly creates a mini program project using the project ID. Then, the third-party service provider may continue to use the project ID to perform a logic such as permission verification of the third-party service provider.

After the project is created, an application debugging interface is displayed. The application debugging interface includes a native debugging region and a configuration region customized by the template plug-in of the third-party service provider.

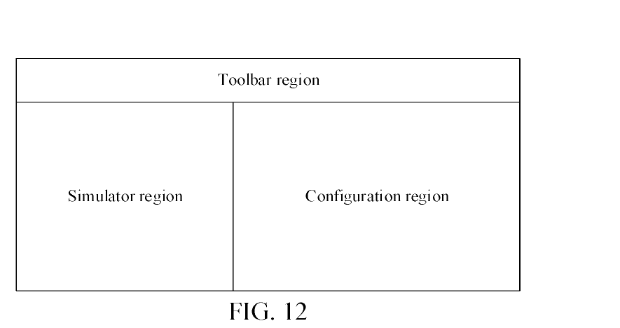

The application debugging interface is an interface generated by rendering based on an interface rendering manner. The interface rendering manner may be embedded rendering or overlay rendering. The application debugging interface may be a first application debugging interface generated based on the embedded rendering manner, or may be a second application debugging interface generated based on the overlay rendering manner. The embedded rendering means that a configuration region configured for configuring a sub-application of the second application development platform is embedded in the first application debugging interface of the first application development platform, as shown in FIG. 12.

The overlay rendering means that an entire webview overlays the native debugging region, that is, the second application debugging interface provided by the second application development platform overlays the simulator region and the toolbar region that are provided by the first application development platform, as shown in FIG. 7. The overlay rendering means that an interface of a plug-in directly overlays an entire window of a tool through the webview, and has a higher degree of freedom for a display function of the plug-in.

However, if the template plug-in selects the overlay rendering manner, the template plug-in needs to obtain layout information of the simulator region and layout information of the toolbar region through the API provided by the tool, and reserve a blank transparent region in the webview, so that the simulator region and the toolbar region can be displayed through the transparent region.

Meanwhile, to enable the developer to operate the native debugging region and the configuration region in the second application debugging interface at the same time, the developer tool automatically moves a view hierarchy of the second application debugging interface to the topmost layer when a mouse is moved to the configuration region. The template plug-in needs to automatically detect a mouse operation event. When the mouse is moved to a region on the second application debugging interface except the configuration region, a preset interface provided by the developer tool is invoked to lower the view hierarchy of the second application debugging interface, so that the operation event can act on the native debugging region through the second application debugging interface, so that the developer can also normally tap/click a related button of the native debugging region.

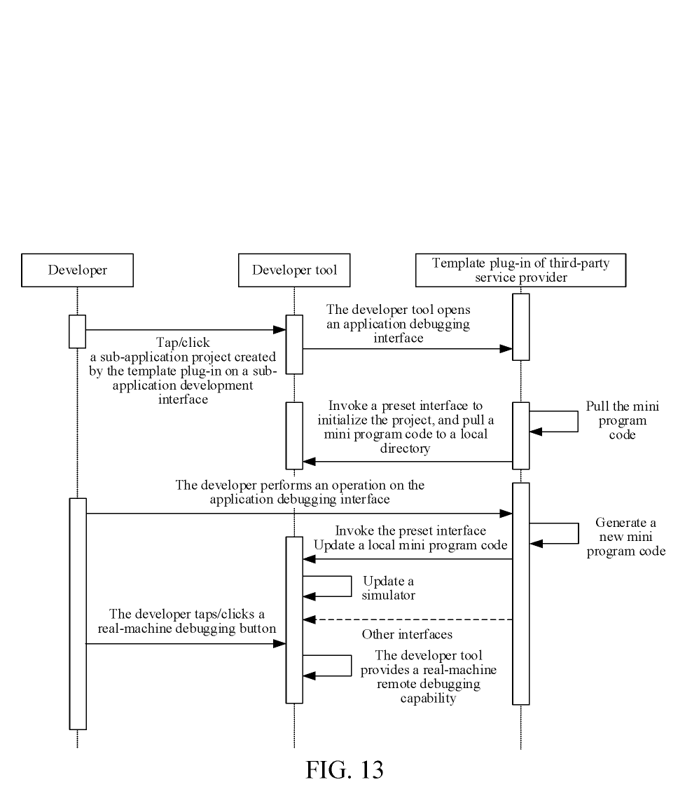

To enable a user to normally use a real-machine debugging capability of the developer tool, the template plug-in needs to transmit, to the developer tool, a mini program code newly generated after the developer performs an operation, as shown in FIG. 13. After the developer enters the project created by the template, the developer tool can match a corresponding template plug-in based on the template used in the project, and decides whether to perform the embedded rendering or the overlay rendering based on a template plug-in configuration file. The template plug-in pulls related information of the project ID and the generated mini program code from the third-party service provider template plug-in background based on the project ID. A background of the template plug-in of the third-party service provider is a second server corresponding to the second application development platform. The template plug-in transmits the mini program code to the developer tool through the API provided by the developer tool. After obtaining the mini program code, the developer tool writes the mini program code into a local cache directory, and then starts to perform a series of initialization, including compiling the mini program code and the like. After the initialization succeeds, an initialization succeed result is returned to a target plug-in. After the initialization succeeds, the developer may perform any operation on the application debugging interface, for example, the real-machine debugging capability provided by the developer tool is used, or a mini program configuration is updated in the configuration region. The template plug-in regenerates a mini program code after the developer updates a service configuration, and transmits a differentiated code to the developer tool through the API provided by the developer tool. The developer tool synchronizes a code file that needs to be updated to corresponding file content of the local cache directory, then recompiles a code, and triggers simulator content update, and latest mini program content is displayed in the simulator region.

This embodiment provides a general-purpose sub-application generation method, so that the third-party service provider can combine a service of the third-party service provider with the developer tool, and the developer can simultaneously use the third-party service provider and the capabilities such as the simulator, real-machine debugging, and remote breakpoint debugging of the developer tool, thereby enhancing development efficiency and experience of the developer. The implementation of the solution enables the third-party service provider to implement expansion by simply developing a template plug-in based on the interface provided by the developer tool, without additionally developing a whole set of mini program debugging solutions. In this way, a requirement of the third-party service provider to expand a mini program development capability is met, the original debugging experience of the mini program developer tool is also retained, and overall development efficiency is effectively enhanced.

Although the operations are displayed sequentially according to the instructions of the arrows in the flowcharts of the embodiments, these operations are not necessarily performed sequentially according to the sequence instructed by the arrows. Unless otherwise explicitly specified in this application execution of the operations is not strictly limited, and the operations may be performed in other sequences. Moreover, at least some of the operations in the flowcharts of the various embodiments may include a plurality of operations or a plurality of stages. These operations or stages are not necessarily performed at the same moment but may be performed at different moments. Execution of these operations or stages is not necessarily performed in sequence, but may be performed in turn or alternately with other operations or at least some of operations or stages of other operations.

Based on the same inventive concept, an embodiment of this application further provides a sub-application generation apparatus for implementing the foregoing sub-application generation method. Implementation solutions provided by the apparatus for solving the problems are similar to the implementation solutions described in the foregoing method. Therefore, for specific limitations in one or more sub-application generation apparatus embodiments provided below, refer to the limitations on the sub-application generation method in the foregoing descriptions. Details are not described herein again.

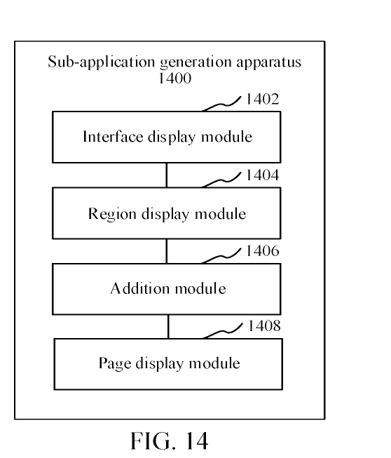

In one embodiment, as shown in FIG. 14, a sub-application generation apparatus 1400 is provided, including: an interface display module 1402, a region display module 1404, an addition module 1406, and a page display module 1408.

The interface display module 1402 is configured to: display a sub-application development interface of a first application development platform, and display, on the sub-application development interface, a template identifier of a sub-application page template provided by a second application development platform.

The region display module 1404 is configured to: display, in response to an identifier selection operation on the template identifier, a simulator region of the first application development platform and a configuration region configured for configuring a sub-application of the second application development platform, and display, in the configuration region, the sub-application page template and a plurality of sub-application components provided by the second application development platform.

The addition module 1406 is configured to add, in response to a component selection operation of selecting from the plurality of sub-application components, a sub-application component selected by the component selection operation into the sub-application page template.

The page display module 1408 is configured to display, in the simulator region, a simulated interaction page formed by simulating running of the sub-application, the simulated interaction page being generated using the sub-application page template and the sub-application component that has been added into the sub-application page template.

In this embodiment, the sub-application development interface of the first application development platform is displayed, to display, on the sub-application development interface of the first application development platform, the template identifier of the sub-application page template provided by the second application development platform. The first application development platform and the second application development platform can be combined, so that a user can select and use, on the first application development platform, the page template provided by the second application development platform to generate the sub-application. In response to the identifier selection operation on the template identifier, the simulator region of the first application development platform and the configuration region configured for configuring the sub-application of the second application development platform are displayed. The sub-application page template provided by the second application development platform and the plurality of sub-application components provided by the second application development platform are displayed in the configuration region. These page templates and components are provided by the second application development platform and are decoupled from the first application development platform itself, so that the user can freely invoke a page template and component of a third-party application development platform. In response to the component selection operation of selection among from the plurality of sub-application components, the sub-application component selected by the component selection operation is added into the sub-application page template. In response to the simulation trigger event for the simulator region, the simulated interaction page of the sub-application is displayed in the simulator region. The simulated interaction page is generated based on the sub-application page template and the sub-application component that has been added into the sub-application page template. These page templates and components are provided by the second application development platform and are decoupled from the first application development platform itself, thereby expanding a sub-application development function through the first application development platform. In addition, the sub-application can be generated through visualized component selection, and a user does not need to write codes, so that a user that does not understand codes can also generate a customized sub-application, thereby making sub-application development easier and enhancing sub-application development efficiency.

In one embodiment, the region display module 1404 is further configured to: display a first application debugging interface in response to the identifier selection operation on the template identifier; and display, on the first application debugging interface, the simulator region provided by the first application development platform and the configuration region configured for configuring the sub-application of the second application development platform.

In this embodiment, the first application debugging interface provided by the first application development platform is displayed in response to the identifier selection operation on the template identifier, so that the simulator region provided by the first application development platform and the configuration region configured for configuring the sub-application of the second application development platform can be simultaneously displayed on the first application debugging interface, and the sub-application configured by the developer in the configuration region can be run in the simulator region. The developer can configure the sub-application and debug the sub-application on the same interface, so that the sub-application development is easier, and it helps to enhance a user experience.

In one embodiment, the first application debugging interface further includes a toolbar region provided by the first application development platform. The page display module 1408 is further configured to: display a simulator trigger control in the toolbar region; and display the simulated interaction page of the sub-application in the simulator region in response to a trigger operation on the simulator trigger control.

In this embodiment, the toolbar region and the simulator region that are provided by the first application development platform, and the configuration region configured for configuring the sub-application of the second application development platform can be displayed on the first application debugging interface of the first application development platform, so that a developer can directly use a function of another development platform on the first application development platform, and the used function can still be implemented by the another development platform. Therefore, a service provided by the second application development platform can be combined with the first application development platform. This greatly enhances a sub-application development capability of the first application development platform.

In one embodiment, a preview control is displayed in the toolbar region. The apparatus further includes:

a graphic code display module configured to: display a first graphic code of the sub-application in the simulator region in response to a trigger operation on the preview control, the first graphic code being configured for being scanned by a parent application run in a scanning terminal, to instruct the parent application run in the scanning terminal to run the sub-application, and display a preview interaction page of the sub-application.

In this embodiment, the first graphic code of the sub-application is displayed in the simulator region in response to the trigger operation on the preview control, so that when the first graphic code is scanned, the sub-application is run through the parent application run in the scanning terminal that scans the first graphic code, and the preview interaction page of the sub-application is displayed, so that the generated sub-application can be run and previewed on another terminal, thereby ensuring that the sub-application can be run in a real machine, and presenting an effect of running the sub-application in the real machine.

In one embodiment, a real-machine debugging control is displayed in the toolbar region. The apparatus further includes:

a graphic code display module, configured to: display a second graphic code of the sub-application in the simulator region in response to a trigger operation on the real-machine debugging control, the second graphic code being configured for being scanned by the parent application run in the scanning terminal, to instruct the parent application run in the scanning terminal to run the sub-application, and display an interaction page of the sub-application and a running log of the sub-application.

In this embodiment, the second graphic code of the sub-application is displayed in the simulator region in response to the trigger operation on the real-machine debugging control, so that when the second graphic code is scanned, the sub-application is run through the parent application run in the scanning terminal that scans the second graphic code, thereby running the sub-application in the real machine, to present an effect of running the sub-application in the real machine. In addition, the interaction page of the sub-application and the running log of the sub-application are displayed, so that a related function of the sub-application can be tested in the real machine, and it is convenient for the developer to directly view the running log of the sub-application in the real machine, thereby enhancing sub-application debugging efficiency.

In one embodiment, the region display module 1404 is further configured to: display, in response to the identifier selection operation on the template identifier, the simulator region of the first application development platform, and display a second application debugging interface overlaying the simulator region, the second application debugging interface including the configuration region configured for configuring the sub-application of the second application development platform and an interaction region except the configuration region, and an operation in the interaction region being able to act on the simulator region.

In this embodiment, in response to the identifier selection operation on the template identifier, the simulator region of the first application development platform is displayed, and the second application debugging interface overlaying the simulator region is displayed. In addition, the second application debugging interface includes the configuration region configured for configuring the sub-application of the second application development platform and the interaction region except the configuration region, so that a degree of freedom of displaying of the configuration region is higher. The operation on the interaction region can act on the simulator region, so that the simulator region can be operated from the interaction region, and configuration in the configuration region and the operation on the simulator region can be implemented on the same interface, thereby effectively expanding functions of the first application development platform. Interface displaying is more flexible and requirements of different users can be met.

In one embodiment, the region display module 1404 is further configured to: obtain, in response to the identifier selection operation on the template identifier, a template plug-in that is bound to the template identifier and is provided by the second application development platform; and determine a plug-in configuration file of the template plug-in, and determine an interface rendering manner based on the plug-in configuration file; and display, based on the interface rendering manner, the simulator region of the first application development platform and the configuration region configured for configuring the sub-application of the second application development platform.

In this embodiment, the template plug-in that is bound to the template identifier and is provided by the second application development platform is obtained in response to the identifier selection operation on the template identifier, to determine the interface rendering manner based on the plug-in configuration file of the template plug-in, so that the simulator region of the first application development platform and the configuration region configured for configuring the sub-application of the second application development platform can be automatically rendered based on the interface rendering manner defined by the second application development platform.

In one embodiment, the region display module 1404 is further configured to: display the first application debugging interface of the first application development platform when the interface rendering manner is embedded rendering, the first application debugging interface including the simulator region of the first application development platform and the configuration region configured for configuring the sub-application of the second application development platform; and when the interface rendering manner is overlay rendering, display the simulator region of the first application development platform, and display the second application debugging interface overlaying the simulator region, the second application debugging interface including the configuration region configured for configuring the sub-application of the second application development platform.

In this embodiment, two interface rendering manners defined by the second application development platform are provided, so that the simulator region and the configuration region can be automatically rendered on the first application development platform based on the interface rendering manners defined by the second application development platform. When the interface rendering manner is the embedded rendering, the simulator region of the first application development platform and the configuration region configured for configuring the sub-application of the second application development platform are rendered to be displayed on the same interface, so that it is convenient for the developer to view and configure the interaction page of the generated sub-application while performing page configuration. When the interface rendering manner is the overlay rendering, the simulator region of the first application development platform is displayed, and the second application debugging interface overlaying the simulator region is displayed. The second application debugging interface includes the configuration region configured for configuring the sub-application of the second application development platform, so that the degree of freedom of displaying of the configuration region is higher, and content in the configuration region can be displayed more completely. This facilitates operations of the developer.

In one embodiment, the apparatus further includes:

a generation module configured to: obtain first layout information of the simulator region of the first application development platform when the interface rendering manner is the embedded rendering; determine, based on the first layout information of the simulator region, second layout information of the configuration region configured for configuring the sub-application of the second application development platform; and generate the first application debugging interface of the first application development platform based on the second layout information and the first layout information.

In this embodiment, when the interface rendering manner is the embedded rendering, the first layout information of the simulator region of the first application development platform is obtained, and the second layout information of the configuration region configured for configuring the sub-application of the second application development platform is determined based on the first layout information of the simulator region, to accurately generate, based on the second layout information and the first layout information, the first application debugging interface into which the simulator region and the configuration region are embedded.

In one embodiment, the apparatus further includes:

a generation module configured to: obtain first layout information of the simulator region of the first application development platform when the interface rendering manner is the overlay rendering; determine, based on the first layout information of the simulator region, second layout information of the configuration region configured for configuring the sub-application of the second application development platform; obtain, based on the second layout information and the first layout information, the second application debugging interface provided by the second application development platform, the second application debugging interface including the configuration region and the interaction region; and display the second application debugging interface, and display the simulator region overlaid by the interaction region of the second application debugging interface, a layout of the simulator region being displayed in the interaction region.

In this embodiment, when the interface rendering manner is the overlay rendering, the first layout information of the simulator region of the first application development platform is obtained, and the second layout information of the configuration region configured for configuring the sub-application of the second application development platform is determined based on the first layout information of the simulator region. The second application debugging interface including the configuration region and the interaction region is obtained based on the second layout information and the first layout information, so that when the second application debugging interface and the simulator region are displayed, the simulator region overlaid by the interaction region of the second application debugging interface can be displayed through the interaction region, and the developer can see the displayed simulated interaction page in the overlaid simulator region.

In one embodiment, the apparatus further includes:

an adjustment module configured to adjust, when a first preset operation in the configuration region is detected, a view hierarchy of the second application debugging interface to be higher than a view hierarchy of the simulator region, the second application debugging interface subjected to view hierarchy adjustment being configured for responding to the operation for the configuration region through the configuration region.

The adjustment module may be configured to adjust, when a second preset operation acting on the interaction region is detected, the view hierarchy of the second application debugging interface to be lower than the view hierarchy of the simulator region, after view hierarchy adjustment, the simulator region being configured for responding to the operation for the interaction region.

In this embodiment, when the first preset operation in the configuration region is detected, it indicates that the developer needs to perform a related configuration operation on the configuration region, and the view hierarchy of the second application debugging interface is adjusted to be higher than the view hierarchy of the simulator region, so that after the view hierarchy adjustment, the developer can directly perform the operation on the configuration region. When the second preset operation acting on the interaction region is detected, it indicates that the developer is to perform a related operation on the simulator region, and the view hierarchy of the second application debugging interface is adjusted to be lower than the view hierarchy of the simulator region, so that after the view hierarchy adjustment, the operation performed by the developer on the interaction region can act on the simulator region. In a case that the second application debugging interface overlays the simulator region, the developer can still normally use a function of the simulator region.

In one embodiment, the apparatus further includes:

a project creation module configured to: run a built-in project creation script of the template plug-in, to obtain a sub-application project identifier; locally create a sub-application development project on the first application development platform based on the sub-application project identifier; and generate, based on the sub-application development project, the simulator region of the first application development platform and the configuration region configured for configuring the sub-application of the second application development platform.

In this embodiment, the sub-application project identifier may be obtained by running the built-in project creation script of the template plug-in, and the sub-application development project is locally created on the first application development platform based on the sub-application project identifier, so that a function of a customized project creation logic of the second application development platform can be provided and used on the first application development platform. Thus, the simulator region of the first application development platform and the configuration region configured for configuring the sub-application of the second application development platform are generated based on the sub-application development project, to implement combination of a debugging function of the first application development platform and a configuration function of the second application development platform.

In one embodiment, the apparatus further includes:

a sub-application code obtaining module configured to: obtain a sub-application code from the second application development platform based on the template plug-in, the sub-application code being generated based on the sub-application page template and the sub-application component that has been added into the sub-application page template; and locally store the sub-application code and run the sub-application code, to obtain the simulated interaction page of the sub-application.

In this embodiment, the second application development platform may generate the sub-application code based on the sub-application page template and the sub-application component that has been added into the sub-application page template, so that the developer can use, on the first application development platform, a page template and a component that are defined by the second application development platform, and can still generate a sub-application code using an original generation logic of the second application development platform, without modifying the generation logic of the sub-application code. The sub-application code may be obtained from the second application development platform through the template plug-in, so as to be locally stored to the first application development platform and run, to obtain the simulated interaction page of the sub-application, thereby effectively expanding the development capability of the first application development platform based on the template plug-in and enabling the first application development platform to be compatible with development logics of different development platforms.

In one embodiment, the interface display module 1402 is further configured to: display at least one platform identifier each corresponding to one second application development platform on the sub-application development interface; and display, on the sub-application development interface in response to an identifier selection operation of selecting from the at least one platform identifier, a template identifier associated with a selected platform identifier, the template identifier being configured for identifying a sub-application page template provided by a second application development platform with the selected platform identifier.

In this embodiment, the platform identifier of the at least one second application development platform is displayed on the sub-application development interface, so that the at least one third-party application development platform can be provided for selection by the developer, and the developer can generate, directly on the first application development platform, a sub-application using a page template and a component that are provided by another application development platform. In response to the identifier selection operation of selecting from at least one platform identifier, the template identifier associated with the selected platform identifier is displayed on the sub-application development interface. The template identifier is configured for identifying the sub-application page template provided by the second application development platform with the selected platform identifier, so that page templates provided by the second application development platform selected by a user can be displayed for selection by the user, to meet different requirements of the user.

In one embodiment, the interface display module 1402 is further configured to: display a template type trigger control on the sub-application development interface; display at least one candidate template type on the sub-application development interface in response to a trigger operation on the template type trigger control; and display, on the sub-application development interface in response to an identifier selection operation of selecting from the at least one platform identifier and a type selection operation of selecting from the at least one candidate template type, the template identifier that belongs to a selected template type and is associated with the selected platform identifier.

In this embodiment, the template type trigger control is displayed on the sub-application development interface, and in response to the trigger operation on the template type trigger control, the at least one candidate template type is displayed on the sub-application development interface, so that the developer can be provided with types of page templates of another development platform on the first application development platform; the page templates of the another development platform can be classified in more detail; and the developer can flexibly select a corresponding template type based on a type of a sub-application that needs to be generated by the developer. Thus, page templates of the another development platform in this type are displayed for flexible selection by the developer.

In one embodiment, the interface display module 1402 is further configured to: display a platform type trigger control on the sub-application development interface; display at least one platform type on the sub-application development interface in response to a trigger operation on the platform type trigger control; and display, on the sub-application development interface in response to a type selection operation of selecting from the at least one platform type, the platform identifier of the at least one second application development platform belonging to a selected platform type.

In this embodiment, the first application development platform displays platform types of different types of second application development platforms on an interface for selection by the developer, so that the different types of second application development platforms can be invoked on the first application development platform, and the different types of second application development platforms can be combined into the first application development platform, to provide a more comprehensive development function for the developer. Any type of sub-application that needs to be generated by the developer can be generated through the first application development platform, without using a particular type of application development platform. This can enhance flexibility and convenience of sub-application development.

The modules in the sub-application generation apparatus may be implemented entirely or partially through software, hardware, or a combination thereof. The foregoing modules may be built in or independent of a processor of a computer device in a form of hardware, or may be stored in a memory of the computer device in a form of software, for the processor to invoke to execute operations corresponding to the foregoing modules.

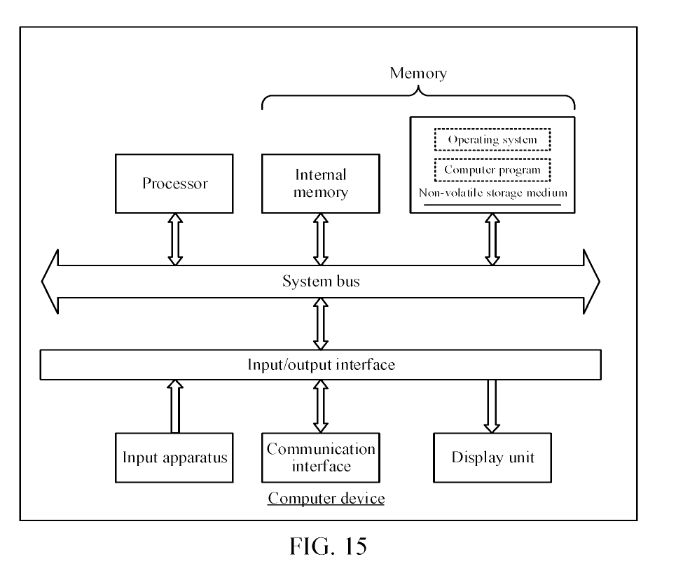

In one embodiment, a computer device is provided. The computer device may be a terminal, an internal structure of which is shown in FIG. 15. The computer device includes a processor, a memory, an input/output interface, a communication interface, a display unit, and an input apparatus. The processor, the memory, and the input/output interface are connected through a system bus. The communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium stores an operating system and computer programs. The internal memory provides an environment for running of the operating system and the computer program in the non-volatile storage medium. The input/output interface of the computer device is configured for exchanging information between the processor and an external device. The communication interface of the computer device is configured for conducting wired or wireless communication with an external terminal. The wireless communication may be implemented through wireless fidelity (WIFI), a mobile cellular network, near field communication (NFC), or another technology. The computer program is executed by the processor to implement a sub-application generation method. The display unit of the computer device is configured to form visual pictures, which may be a display screen, a projection apparatus or a virtual reality imaging apparatus. The display screen may be a liquid crystal display screen or an e-ink display screen. The input apparatus of the computer device may be a touch layer overlaying the display screen, or may be a button, a trackball, or a touch pad arranged on a housing of the computer device, or may be an external keyboard, touch pad, a mouse or the like.

A person skilled in the art can understand that the structure shown in FIG. 15 is merely a partial structure related to a solution in this application, and does not constitute a limitation on the computer device to which the solution in this application is applied. Specifically, the computer device may include more or fewer components than those shown in the figure, or some components may be combined, or a different component layout may be used.

In one embodiment, a computer device is further provided, including a memory and a processor. The memory has a computer program stored therein. The processor, when executing the computer program, implements the operations in the foregoing method embodiments.

In one embodiment, a computer-readable storage medium is provided, having a computer program stored therein. The computer program, when executed by a processor, implements the operations in the foregoing method embodiments.

In one embodiment, a computer program product is provided, including a computer program. The computer program, when executed by a processor, implements the operations in the foregoing method embodiments.

User information (including but not limited to user device information and user personal information) and data (including but not limited to data for analysis, stored data, displayed data, and the like) involved in the present disclosure are information and data authorized by a user or fully authorized by all parties, and the acquisition, use, and processing of the relevant data need to comply with relevant laws, regulations, and standards of relevant countries and regions.

A person of ordinary skill in the art may understand that all or some of the procedures of the method in the foregoing embodiments may be implemented by the computer-readable instructions that instruct relevant hardware. The computer program may be stored in a non-volatile computer-readable storage medium. When the computer program is executed, the procedures of the foregoing method embodiments may be implemented. Any reference to a memory, a database, or other media used in the embodiments provided in this application can include at least one of a non-volatile memory or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random-access memory (RAM) and an external cache. For the purpose of illustration rather than limitation, the RAM may be in various forms, such as a static random access memory (SRAM), or a dynamic random access memory (DRAM). The databases involved in the various embodiments provided in this application may include at least one of a relational database or a non-relational database. The non-relational database may include, but is not limited to, a blockchain-based distributed database and the like. The processor involved in the embodiments provided in this application may be, but is not limited to, a general-purpose processor, a central processing unit, a graphics processing unit, a digital signal processor, a programmable logic device, a quantum computing-based data processing logic device, or the like.

All the technical features of the above embodiments can be combined randomly. For the sake of brevity, all possible combinations of all the technical features in the foregoing embodiments are not described. However, these technical features shall all be considered to fall within the scope of this specification as long as there is no contradiction in their combinations.

The foregoing embodiments merely express several implementations of this application. The descriptions thereof are relatively specific and detailed, but are not understood as limitations on the scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A sub-application generation method comprising:
displaying a sub-application development interface of a first application development platform;
displaying, on the sub-application development interface, a template identifier of a sub-application page template provided by a second application development platform;
displaying, in response to an identifier selection operation on the template identifier, a simulator region of the first application development platform and a configuration region configured for configuring a sub-application of the second application development platform;
displaying, in the configuration region, the sub-application page template and a plurality of sub-application components provided by the second application development platform;
adding, in response to a component selection operation of selecting from the plurality of sub-application components, at least one sub-application component selected by the component selection operation into the sub-application page template; and
displaying, in the simulator region, a simulated interaction page formed by simulating running of the sub-application generated using the sub-application page template and the at least one sub-application component.

2. The method according to claim 1, wherein displaying the simulator region and the configuration region includes:
displaying an application debugging interface; and
displaying, on the application debugging interface, the simulator region and the configuration region.

3. The method according to claim 2, wherein:
a toolbar region provided by the first application development platform is further displayed on the application debugging interface; and
displaying the simulated interaction page includes:
displaying a simulator trigger control in the toolbar region; and
displaying, in the simulator region in response to a trigger operation on the simulator trigger control, the simulated interaction page.

4. The method according to claim 3, further comprising:
displaying a graphic code of the sub-application in the simulator region in response to a trigger operation on a preview control displayed in the toolbar region, the graphic code being configured for being scanned by a parent application run in a scanning terminal, to instruct the parent application run to run the sub-application, and display a preview interaction page of the sub-application.

5. The method according to claim 3, further comprising:
displaying a graphic code of the sub-application in the simulator region in response to a trigger operation on a real-machine debugging control displayed in the toolbar region, the graphic code being configured for being scanned by a parent application run in a scanning terminal, to instruct the parent application to run the sub-application, and display an interaction page of the sub-application and a running log of the sub-application.

6. The method according to claim 1, wherein displaying the simulator region and the configuration region includes:
displaying the simulator region, and displaying an application debugging interface overlaying the simulator region, the application debugging interface including the configuration region and an interaction region except the configuration region, and an operation triggered in the interaction region acting on the simulator region.

7. The method according to claim 1, wherein displaying the simulator region and the configuration region includes:
obtaining a template plug-in provided by the second application development platform and bound to the template identifier;
determining a plug-in configuration file of the template plug-in, and determining an interface rendering manner based on the plug-in configuration file; and
displaying, based on the interface rendering manner, the simulator region and the configuration region.

8. The method according to claim 7, wherein:
the interface rendering manner is embedded rendering; and
displaying, based on the interface rendering manner, the simulator region and the configuration region includes:
displaying an application debugging interface of the first application development platform, the application debugging interface including the simulator region and the configuration region.

9. The method according to claim 8, further comprising:
obtaining first layout information of the simulator region;
determining, based on the first layout information, second layout information of the configuration region; and
generating the application debugging interface based on the second layout information and the first layout information.

10. The method according to claim 7, wherein:
the interface rendering manner is overlay rendering; and
displaying, based on the interface rendering manner, the simulator region and the configuration region includes:
displaying the simulator region, and displaying an application debugging interface overlaying the simulator region, the application debugging interface including the configuration region.

11. The method according to claim 10, wherein displaying the simulator region and displaying the application debugging interface overlaying the simulator region includes:
obtaining first layout information of the simulator region;
determining, based on the first layout information, second layout information of the configuration region;
obtaining, based on the second layout information and the first layout information, the application debugging interface provided by the second application development platform, the application debugging interface including the configuration region and the interaction region; and
displaying the application debugging interface, and displaying the simulator region overlaid by the interaction region, a layout of the simulator region being displayed in the interaction region.

12. The method according to claim 11, further comprising:
adjusting, in response to detecting a preset operation in the configuration region, a view hierarchy of the application debugging interface to be higher than a view hierarchy of the simulator region, the application debugging interface after being subjected to view hierarchy adjustment being configured for responding to the operation for the configuration region through the configuration region.

13. The method according to claim 11, further comprising:
adjusting, in response to detecting a preset operation acting on the interaction region, a view hierarchy of the application debugging interface to be lower than a view hierarchy of the simulator region, after view hierarchy adjustment, the simulator region being configured for responding to the operation for the interaction region.

14. The method according to claim 7, further comprising:
running a built-in project creation script of the template plug-in, to obtain a sub-application project identifier;
locally creating a sub-application development project on the first application development platform based on the sub-application project identifier; and
generating, based on the sub-application development project, the simulator region and the configuration region.

15. The method according to claim 7, further comprising:
obtaining a sub-application code from the second application development platform based on the template plug-in, the sub-application code being generated based on the sub-application page template and the at least one sub-application component; and
locally storing the sub-application code and running the sub-application code, to obtain the simulated interaction page of the sub-application.

16. The method according to claim 1, wherein displaying the template identifier includes:
displaying at least one platform identifier on the sub-application development interface; and
displaying, on the sub-application development interface and in response to an identifier selection operation to select one platform identifier from the at least one platform identifier, the template identifier associated with the one platform identifier, the template identifier being configured for identifying the sub-application page template provided by the second application development platform having the one platform identifier.

17. The method according to claim 16, further comprising:
displaying a template type trigger control on the sub-application development interface; and
displaying at least one candidate template type on the sub-application development interface in response to a trigger operation on the template type trigger control;
wherein displaying, on the sub-application development interface and in response to the identifier selection operation, the template identifier associated with the one platform identifier includes:
displaying, on the sub-application development interface and in response to the identifier selection operation and a type selection operation of selecting one template type from the at least one candidate template type, the template identifier that belongs to the one template type and is associated with the one platform identifier.

18. The method according to claim 16, wherein displaying the at least one platform identifier on the sub-application development interface includes:
displaying a platform type trigger control on the sub-application development interface;
displaying at least one platform type on the sub-application development interface in response to a trigger operation on the platform type trigger control; and
displaying, on the sub-application development interface and in response to a type selection operation of selecting one platform type from the at least one platform type, the at least one platform identifier belonging to the one platform type.

19. A computer device comprising:
a memory storing a computer program; and
a processor configured to execute the computer program to:
display a sub-application development interface of a first application development platform;
display, on the sub-application development interface, a template identifier of a sub-application page template provided by a second application development platform;
display, in response to an identifier selection operation on the template identifier, a simulator region of the first application development platform and a configuration region configured for configuring a sub-application of the second application development platform;
display, in the configuration region, the sub-application page template and a plurality of sub-application components provided by the second application development platform;
add, in response to a component selection operation of selecting from the plurality of sub-application components, at least one sub-application component selected by the component selection operation into the sub-application page template; and
display, in the simulator region, a simulated interaction page formed by simulating running of the sub-application generated using the sub-application page template and the at least one sub-application component.

20. A non-transitory computer-readable storage medium storing a computer program that, when executed by a processor, causes a computer device including the processor to:
display a sub-application development interface of a first application development platform;
display, on the sub-application development interface, a template identifier of a sub-application page template provided by a second application development platform;
display, in response to an identifier selection operation on the template identifier, a simulator region of the first application development platform and a configuration region configured for configuring a sub-application of the second application development platform;
display, in the configuration region, the sub-application page template and a plurality of sub-application components provided by the second application development platform;
add, in response to a component selection operation of selecting from the plurality of sub-application components, at least one sub-application component selected by the component selection operation into the sub-application page template; and
display, in the simulator region, a simulated interaction page formed by simulating running of the sub-application generated using the sub-application page template and the at least one sub-application component.
